(19) United States
(12) Patent Application Publication
(10) Pub. No.: US 2006/0104872 A1
(43) Pub. Date: May 18, 2006

(54) Fluidized-bed gasification furnace

(76) Inventors: Ryuichi Ishikawa, Tokyo (JP); Chikao Goke, Tokyo (JP); Shigeru Kosugi, Tokyo (JP); Hiromitsu Cho, Tokyo (JP)

Correspondence Address: WENDEROTH, LIND & PONACK, L.L.P., 2033 K STREET N. W., SUITE 800, WASHINGTON, DC, 20006-1021, US

(21) Appl. No.: 10/533,667

(22) PCT Filed: Nov. 14, 2003
(86) PCT No.: PCT/JP03/14500

§ 371 Date: May 3, 2005

(30) Foreign Application Priority Data
Nov. 15, 2002 (JP) 2002-332696
May 9, 2003 (JP) 2003-132201

(51) Int. Cl. B32B 27/04; F27B 15/00; B01J 8/18

(52) U.S. Cl. 422/139; 422/145

(57) ABSTRACT

The present invention relates to a fluidized-bed gasification furnace in a gasification and slagging combustion system for gasifying combustibles, delivering produced gas and char into a slagging combustion furnace, and combusting the gas and char at a high temperature and melting ash in the slagging combustion furnace. The fluidized-bed gasification furnace includes a fluidized bed (11) having a substantially rectangular horizontal cross section in which combustibles is gasified in a circulating flow of the fluidized medium, and at least one incombustibles discharging portion (18) defined at at least one side of the fluidized bed for discharging the fluidized medium and incombustibles accompanying the fluidized medium.

### TECHNICAL FIELD

The present invention relates to a fluidized-bed gasification furnace in a gasification and slagging combustion system for gasifying combustibles including municipal wastes, industrial wastes, biomass, and the like, delivering produced gas and char (solid carbon) into a slagging combustion furnace, and combusting the gas and char at a high temperature and melting ash in the slagging combustion furnace.

### BACKGROUND ART

In recent years, there has been employed a process of gasifying (pyrolyzing) wastes such as municipal wastes, industrial wastes, biomass or medical wastes in a reducing atmosphere within a fluidized-bed gasification furnace, introducing gas, char and ash produced by gasification into a slagging combustion furnace, and combusting the gas and char at a high temperature and melting the ash in the slagging combustion furnace.

One conventional fluidized-bed gasification furnace is disclosed in Japanese laid-open patent publication No. 2-147692, for example. In the fluidized-bed gasification furnace disclosed in this patent publication, a circulating flow of a fluidized medium is created within a fluidized bed by giving different mass velocities to a gasifying agent that is ejected from the furnace bottom, thereby gasifying even considerably small particles of char that are produced from coal in the fluidized bed. However, the disclosed fluidized-bed gasification furnace puts emphasis on a design for preventing char from being scattered from the gasification furnace because such gasification furnace is not expected to provide a slagging combustion furnace in a subsequent stage of the gasification furnace.

A fluidized-bed gasification and slagging combustion system comprises a two-furnace structure including a gasification furnace in a first stage and a slagging combustion furnace in a subsequent stage. In the fluidized-bed gasification and slagging combustion system, the gasification furnace serves to produce fine particles of combustibles and ash and deliver them in a high heating value state into the slagging combustion furnace. Furthermore, the gasification furnace should preferably have a buffering function for absorbing qualitative and quantitative fluctuations of materials to be treated, averaging qualitative and quantitative fluctuations of produced gas, and delivering the produced gas to the subsequent stage. Specifically, in the fluidized-bed gasification furnace, gasification of the materials such as wastes needs to be maintained stably.

Another fluidized-bed gasification furnace is disclosed in Japanese laid-open patent publication No. 7-332614 which is an earlier patent application filed by the present applicant. According to the fluidized-bed gasification furnace disclosed in this patent publication, since a temperature of a fluidized bed is relatively low, pyrolysis gas and pyrolysis residues are stably supplied to a swirling-type slagging combustion furnace, and hence highly stable combusting conditions are established in the swirling-type slagging combustion furnace. Therefore, the temperature in the swirling-type slagging combustion furnace can be maintained stably at a minimum temperature level required for slagging the ash. For these reasons, the slag is stably discharged from the slagging combustion furnace, and heavy metals are sufficiently prevented from being eluted because of the stable quality of the slag. Furthermore, because no abnormally high temperatures are experienced in the swirling-type slagging combustion furnace, it is possible to prolong the service life of the refractory material of the swirling-type slagging combustion furnace.

In addition, the furnaces and the overall system are rendered compact because the waste materials are thermally melted by the quantity of heat themselves and the total amount of charged gas required to combust the waste materials is reduced (so-called low-air-ratio combustion). Thus, the fluidized-bed gasification furnace in the gasification and slagging combustion system is entirely different in technical concept from a fluidized-bed furnace which has been used as an incinerator before the gasification and slagging combustion system has been developed.

When the proportion of partial combustion in a fluidized-bed gasification furnace is reduced, and the temperature of the fluidized bed is lowered, the concentration of char in the fluidized medium necessarily increases. If the char is discharged together with incombustibles out of the system, then a heat loss will occur. Therefore, it is important to prevent the char from being discharged from the fluidized-bed gasification furnace. In order to prevent the char from being discharged, it is necessary to separate the char efficiently from the incombustibles due to active fluidization of the fluidized medium in the fluidized bed. Consequently, a conventional fluidized-bed gasification furnace having a circular horizontal cross section needs to be capable of separating incombustibles (fluidized medium) and char efficiently from each other.

A circulation-type fluidized-bed furnace is highly effective in forming a circulating flow of the fluidized medium in the fluidized bed for thereby dispersing heat and preventing heat from being locally retained. An existing bubbling fluidized-bed furnace is problematic in that because diffusion force of the fluidized medium laterally is weak, the temperature of a region where materials to be treated are charged (heat density) increases, and the heat density in a region where materials to be treated are not sufficiently dispersed decreases.

It is an object of the present invention to solve the above problems and thus make the fluidized-bed furnace compact. Specifically, a circulating flow of the fluidized medium is formed to uniformize temperatures in the overall fluidized bed and prevent heat from being localized in the fluidized bed. Thus, it is possible to prevent an abnormal state of fluidization from occurring owing to clinker formed in local high-temperature regions. Although the fluidized-bed gasification furnace disclosed in Japanese laid-open patent publication No. 7-332614, referred to above, has been described as only an example, in the fluidized-bed gasification furnace of a gasification and slagging combustion system, an inclined furnace bottom, a reflective wall referred to as a deflector, and a technique for developing different velocities of a fluidizing gas from the furnace bottom are combined appropriately to produce a circulating flow of the fluidized medium.

Using such an “appropriate combination” of those elements (or factors) to form a circulating flow of the fluidized medium is not disclosed in Japanese laid-open patent publication No. 2-147692 referred to above. If char is discharged together with incombustibles from an incombustibles discharge device, and a gas in the furnace cannot be sufficiently sealed in an incombustibles discharging chute, then the char discharged together with incombustibles may be combusted in an incombustibles discharging chute, thus tending to produce clinker.

In order to form a circulating flow of the fluidized medium, a new gasification furnace needs to meet a demand for avoiding an occurrence of an abnormal state of fluidization in a fluidized-bed gasification furnace by introducing a fluidizing gas at all times into the fluidized-bed gasification furnace from its furnace bottom at a minimum rate (unit Umf “minimum fluidization velocity”) that is required to fluidize the fluidized medium.

A gasification and slagging combustion system is required to treat a large quantity of waste materials. The value of a bed load in the incinerator of an incinerating facility (the weight [kg] of materials that can be treated in a unit time [h] per unit area [m²] of a hearth) is approximately in the range from 400 to 500 kg/m²·h. On the other hand, the value of a bed load in the gasification furnace is approximately in the range from 900 to 1200 kg/m²·h, and is thus much greater than the load imposed on the hearth in the incinerator. The waste materials may include various incombustibles such as valuable metals, glass, debris, etc. If the waste materials include those incombustibles, then the total amount of incombustibles in the fluidized bed is necessarily greater in proportion to the charged quantity of waste materials than the conventional incinerator, and incombustibles that are not gasified are accumulated in the fluidized bed. Thus, the concentration of incombustibles in the fluidized medium tends to be relatively high.

As the concentration of incombustibles in the fluidized medium becomes higher, the possibility of an abnormal state of fluidization becomes higher. Thus, it is a highly important subject to discharge incombustibles smoothly from the fluidized bed for stably operating the gasification and slagging combustion system. However, it has been found out that a gasification furnace having a hearth whose horizontal cross section is circular is disadvantageous with respect to the above subject.

Further, in a gasification and slagging combustion system, it is an absolute condition required to keep a negative pressure in the fluidized-bed furnace and to prevent a gas component (unburned gas) from leaking out of the fluidized-bed furnace. Therefore, all possible measures have to be taken to ensure sealing of the pressure in the fluidized-bed furnace, and a new gasification furnace needs to meet such a requirement.

### DISCLOSURE OF THE INVENTION

The present invention has been made in view of the foregoing drawbacks. It is an object of the present invention to provide a fluidized-bed gasification furnace which can stably continue a gasification process, efficiently classify char and a fluidized medium in a fluidized bed and convert the char into fine particles, supply the fine particles of the char to a slagging combustion furnace, prevent the char from being introduced into an incombustibles discharging path, and allow the fluidized medium including incombustibles to fall smoothly from the fluidized bed through the incombustibles discharging path into an incombustibles discharging apparatus without stagnation, and provide an excellent sealing capability for the incombustibles discharging path.

Another object of the present invention is to provide a fluidized-bed gasification furnace which can enlarge its hearth in size while maintaining the above functions.

In order to achieve the above objects, according to the present invention, there is provided a fluidized-bed gasification furnace for gasifying combustibles, comprises: a fluidized bed having a substantially rectangular horizontal cross section, a circulating flow of a fluidized medium being formed in the fluidized bed, and combustibles supplied to the fluidized bed being gasified in the circulating flow of the fluidized medium to produce gas and char; and at least one incombustibles discharging portion defined at at least one side of the fluidized bed for discharging the fluidized medium and incombustibles accompanying the fluidized medium, the at least one incombustibles discharging portion being disposed at the lower end of the fluidized bed.

With the above arrangement, since the fluidized bed has a substantially rectangular horizontal cross section and the fluidized bed has a circulating flow of a fluidized medium having a descending flow (descending fluidized bed) of the fluidized medium and an ascending flow (ascending fluidized bed) of the fluidized medium, the width of the hearth corresponding to the ascending fluidized bed is not smaller compared with the width of the hearth corresponding to the descending fluidized bed unlike the conventional cylindrical fluidized-bed gasification furnace. Therefore, a moving distance of the fluidized medium in the fluidized bed can be lengthened. Thus, char is sufficiently turned into fine particles, and char and incombustibles can efficiently be classified. The char is thus prevented from entering the incombustibles discharging portion.

Because it is possible to increase the area (or areas) of the incombustibles discharging portion (or portions) by defining the incombustibles discharging portion (or portions) at one side (or a pair of facing sides) of the fluidized bed, the speed at which the fluidized medium is drawn out for discharging the incombustibles can be reduced, and hence char is suppressed to be mixed with the incombustibles discharged from the furnace.

Because the incombustibles discharging portions for discharging the fluidized medium and the incombustibles accompanying the fluidized medium are continuously provided below the circulating flow of the fluidized medium, portions between the incombustibles discharging portions do not present an obstacle to the downward movement of the fluidized medium unlike the conventional cylindrical fluidized-bed gasification furnace, and the fluidized medium in the fluidized bed moves smoothly and downwardly to the incombustibles discharging portions. The incombustibles move smoothly from the descending fluidized bed to the ascending fluidized bed because the circulating flow of the fluidized medium is not dispersed.

Since the horizontal cross section of the fluidized bed is of a substantially rectangular shape or a shape which can be modularized, it is possible to increase the size of the hearth while maintaining the function of the gasification furnace irrespective of the magnitude of the area of the hearth.

In a preferred aspect of the present invention, the at least one incombustibles discharging portion comprises two incombustibles discharging portions at a pair of facing sides of the fluidized bed.

In a preferred aspect of the present invention, the fluidized bed is surrounded by furnace walls having a substantially rectangular inner surface in horizontal cross section.

In a preferred aspect of the present invention, the incombustibles discharging portion is provided below a central portion of the fluidized bed.

In a preferred aspect of the present invention, a freeboard located above the fluidized bed has a substantially circular horizontal cross section.

The freeboard of the gasification furnace has a function to separate pyrolysis gas, char and ash, and the fluidized medium that are blown upwardly from the fluidized bed, and deliver the pyrolysis gas, char, and ash to a slagging combustion furnace at a subsequent stage. Therefore, the freeboard has a cross-sectional area for setting the flow velocity in a predetermined range, and needs to have a sufficient height for preventing the fluidized medium from being scattered. Thus, the freeboard of the gasification furnace is required to have a certain size, and has its inner surface made of a refractory material because of the temperature range in which the freeboard is used. In order for the freeboard which defines a space free of contents to have structural strength, the freeboard should have a substantially circular horizontal cross section. Because of the substantially circular horizontal cross section, any reinforcing members required by the freeboard can greatly be reduced. If the freeboard has a rectangular horizontal cross section, then stresses tend to concentrate on corners of the freeboard due to thermal expansion of the refractory material, thus causing the refractory material to be damaged or project from the wall surface. However, the freeboard which is of a substantially circular horizontal cross section greatly prolongs the service life of the refractory material and greatly reduces expenses for repairing the refractory material.

In a preferred aspect of the present invention, an apparatus for forming the circulating flow of the fluidized medium comprises a fluidized-bed bottom inclined toward the incombustibles discharging portion, and a fluidizing gas supplying apparatus for supplying fluidizing gases having substantially different mass velocities from the inclined fluidized-bed bottom.

As described above, the apparatus for forming the circulating flow of the fluidized medium has a fluidized-bed bottom inclined toward the incombustibles discharging portion, and a fluidizing gas supplying apparatus for ejecting a fluidizing gas having a greater mass velocity and a fluidizing gas having a smaller mass velocity from the inclined fluidized-bed bottom. The apparatus for forming the circulating flow of the fluidized medium further has a deflector. Consequently, the fluidized medium and the incombustibles accompanying the fluidized medium are given forces so as to move in the fluidized bed downwardly toward the incombustibles discharging portion due to the inclined fluidized-bed bottom, and hence can smoothly be directed toward the incombustibles discharging portion.

By forming a circulating flow of the fluidized medium, the fluidized-bed gasification furnace converts combustibles and ash contained in the supplied combustibles into fine particles, and delivers the fine particles with a large quantity of heat to the slagging combustion furnace that is disposed at the subsequent stage of the fluidized-bed gasification furnace. The fluidizing gas supplying apparatus for supplying a fluidizing gas having a smaller mass velocity can form a slowly descending fluidized bed, and the fluidizing gas supplying apparatus for supplying a fluidizing gas having a greater mass velocity can form an active ascending fluidized bed. Therefore, after the supplied combustibles are swallowed by the slowly descending fluidized bed, the supplied combustibles can slowly be gasified. By forming a circulating flow of the fluidized medium, the temperatures in the overall fluidized bed are uniformized, and heat is prevented from being localized in the fluidized bed. Therefore, it is possible to prevent an abnormal state of fluidization from occurring owing to clinker formed in local high-temperature regions.

In a preferred aspect of the present invention, a fluidized-bed bottom is inclined toward the incombustibles discharging portion and has an end portion connected to the incombustibles discharging portion, the end portion is inclined at 45 degrees or more, and a fluidizing gas is blown into from the end portion.

In the fluidized bed having a substantially rectangular horizontal cross section, the combustibles are led together with the fluidized medium by the circulating flow of the fluidized medium along the inclined furnace bottom to the incombustibles discharging portion. Inasmuch as the fluidized medium is present as a fixed bed in the incombustibles discharging portion, the incombustibles may possibly be deposited at the end portion of the furnace bottom connected to the incombustibles discharging portion. According to the present invention, since the end portion connected to the incombustibles discharging portion is sharply inclined at 45 degrees or more, and a fluidizing gas is also supplied from the inclined end portion, the fluidized medium which has been fluidized moves along the sharply inclined end portion, and hence the incombustibles are discharged without being stagnated and deposited.

In a preferred aspect of the present invention, the fluidized-bed gasification furnace further comprises: a vertical chute having a fixed length which is substantially vertically disposed and communicates with the incombustibles discharging portion; and an incombustibles discharging apparatus for discharging the incombustibles from the fluidized-bed gasification furnace, the incombustibles discharging apparatus being provided below the vertical chute to communicate with the vertical chute.

In a preferred aspect of the present invention, the incombustibles discharging apparatus discharges the incombustibles horizontally.

As described above, the vertical chute of a fixed length is disposed substantially vertically so as to be in communication with the incombustibles discharging portion for allowing incombustibles to be discharged smoothly without being stagnant in the vertical chute. The vertical chute is densely filled with the fluidized medium, which provides a material sealing action to prevent unburned gas and the fluidizing gas from leaking to the incombustibles discharging path. Unburned components such as char moving downwardly to the incombustibles discharging path are prevented from being combusted, thus producing no clinker.

An inclined chute provides a weak material sealing action and tends to allow incombustibles to be stagnant. Since such inclined chute is eliminated, the ability to discharge incombustibles can be increased without impairing the sealing capability. The vertical chutes and the incombustibles discharging apparatus which combines the vertical chutes are structurally simple and can easily be installed. In order to keep the sealing capability for the incombustibles discharging chute, it is suitable for the vertical region of the chute to have a length of about 2 m.

Specifically, the horizontal cross section of the fluidized bed is substantially rectangular, and the vertical chute (e.g., a single chute) of a fixed length is disposed substantially vertically in communication with the incombustibles discharging portion. Because any special device (a conveyor or an inclined chute) which has heretofore been indispensable for combining four incombustibles discharging chutes is not required, there is no danger for incombustibles to become stagnant in the chute, and the incombustibles can be discharged more reliably.

A material seal can be maintained even if the under-furnace height of the system is smaller than that of the conventional system. Consequently, the height of the overall system which has posed a problem in the layout of various devices of the system, particularly the height of the combustible supply device, can be reduced as a whole.

According to another aspect of the present invention, there is provided a fluidized-bed gasification furnace for gasifying combustibles, comprises: a fluidized-bed having a substantially rectangular horizontal cross section; and a freeboard having a substantially circular horizontal cross section, wherein a circulating flow of a fluidized medium is formed in the fluidized bed, and combustibles supplied to the fluidized bed are gasified to generate gas and char.

According to another aspect of the present invention, there is provided a fluidized-bed gasification and slagging combustion system, comprises: any of the fluidized-bed gasification furnaces described above; and a slagging combustion furnace for combusting the gas and char produced in the fluidized-bed gasification furnace and melting ash.

### BRIEF DESCRIPTION OF DRAWINGS

FIGS. 1A and 1B are views showing a general structure of a conventional fluidized-bed gasification furnace, and FIG. 1A is a vertical cross-sectional view and FIG. 1B is a cross-sectional view taken along line IB-IB of FIG. 1A;

FIG. 2 is an enlarged view of a hearth region shown in FIG. 1A;

FIG. 3 is a cross-sectional view taken along line III-III of FIG. 2;

FIGS. 4A through 4C are views showing a general structure of a fluidized-bed gasification furnace according to the present invention, and FIG. 4A is a vertical cross-sectional view, FIG. 4B is a horizontal cross-sectional view and FIG. 4C is an enlarged view of a portion A shown in FIG. 4A;

FIG. 5 is a cross-sectional view taken along line V-V of FIG. 4A;

FIG. 6 is a cross-sectional view taken along line VI-VI of FIG. 5;

FIG. 7 is a cross-sectional view taken along line VII-VII of FIG. 5;

FIGS. 8A and 8B are views showing a general structure of a fluidized-bed gasification furnace according to the present invention, and FIG. 8A is a vertical cross-sectional view and FIG. 8B is a horizontal cross-sectional view;

FIGS. 9A and 9B are views for comparing the functions of a conventional fluidized-bed gasification furnace and a fluidized-bed gasification furnace according to the present invention;

FIG. 10 is a horizontal cross-sectional view of a furnace section of a fluidized-bed gasification furnace according to the present invention;

FIG. 11 is a horizontal cross-sectional view of a modified furnace section of the fluidized-bed gasification furnace according to the present invention;

FIG. 12 is a horizontal cross-sectional view of a modified furnace section of the fluidized-bed gasification furnace according to the present invention;

FIG. 13 is a horizontal cross-sectional view of a modified furnace section of the fluidized-bed gasification furnace according to the present invention;

FIGS. 14A and 14B are views showing a general structure of a fluidized-bed gasification furnace according to the present invention, and FIG. 14A is a horizontal cross-sectional view and FIG. 14B is a vertical cross-sectional view;

FIGS. 15A and 15B are views showing a general structure of a fluidized-bed gasification furnace according to the present invention, and FIG. 15A is a horizontal cross-sectional view and FIG. 15B is a vertical cross-sectional view;

FIG. 16A is a cross-sectional view (corresponding to the cross-sectional view taken along line VI-VI of FIG. 5) taken along line XVIA-XVIA of FIG. 16B, and FIG. 16B is a cross-sectional view taken along line XVIB-XVIB of FIG. 16A;

FIG. 17 is a vertical cross-sectional view showing a general structure of a fluidized-bed gasification furnace according to the present invention;

FIG. 18 is a perspective view showing an appearance of a fluidized-bed gasification furnace according to the present invention;

FIG. 19 is a cross-sectional view taken along line XIX-XIX of FIG. 18;

FIG. 20 is a cross-sectional view taken along line XX-XX of FIG. 18;

FIG. 21 is a cross-sectional view taken along line XXI-XXI of FIG. 18;

FIG. 22 is a schematic view showing an arrangement of a gasification apparatus having a fluidized-bed gasification furnace according to the present invention;

FIG. 23 is a schematic view showing an arrangement of a gasification and slagging combustion system which incorporates a fluidized-bed gasification furnace according to the present invention;

FIG. 24 is a schematic view showing an arrangement of a gasifying and reforming apparatus which incorporates a fluidized-bed gasification furnace according to the present invention;

FIG. 25 is a horizontal cross-sectional view showing a structure of a modular-type fluidized-bed gasification furnace according to the present invention;

FIG. 26 is a horizontal cross-sectional view showing a structure of a modular-type fluidized-bed gasification furnace according to the present invention;

FIG. 27 is a perspective view of a modular-type fluidized-bed gasification furnace according to the present invention, as viewed obliquely from above;

FIG. 28 is a vertical cross-sectional view showing a general structure of a fluidized-bed gasification furnace according to the present invention;

FIG. 29 is a vertical cross-sectional view showing a general structure of a fluidized-bed gasification furnace according to the present invention;

FIG. 30 is a cross-sectional view taken along line XXX-XXX of FIG. 28;

FIG. 31 is a perspective view of a fluidized-bed gasification furnace according to the present invention, as viewed obliquely from above; and

FIGS. 32A through 32D are diagrams showing examples of mass velocity distributions from the center of the furnace to the incombustibles discharging port of a fluidized-bed gasification furnace.

### BEST MODE FOR CARRYING OUT THE INVENTION

A fluidized-bed gasification furnace according to embodiments of the present invention will be described in greater detail with reference to the drawings. The embodiments of the present invention will be described in comparison with conventional arrangements.

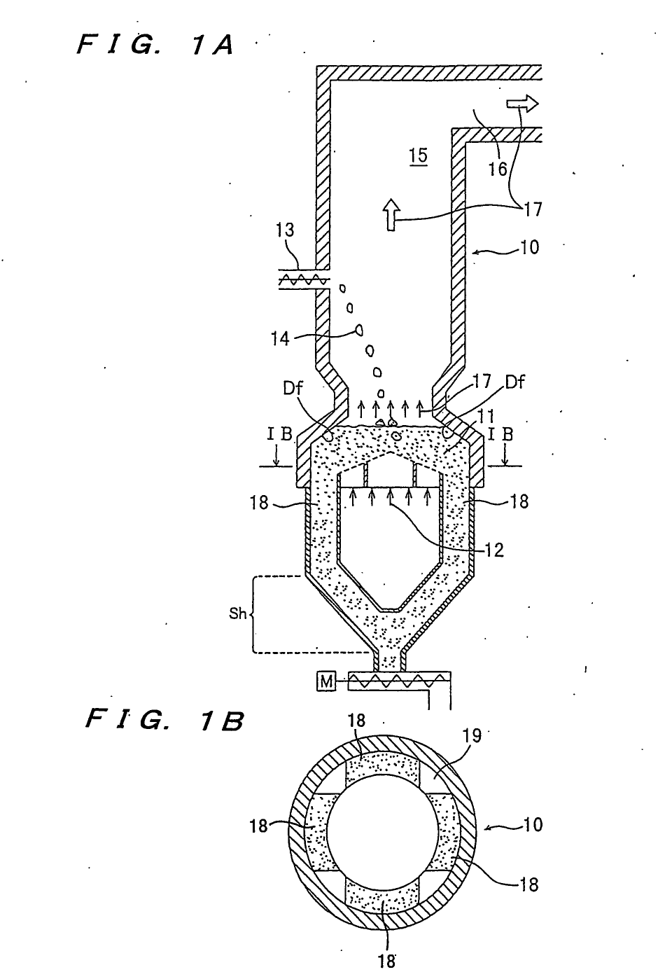

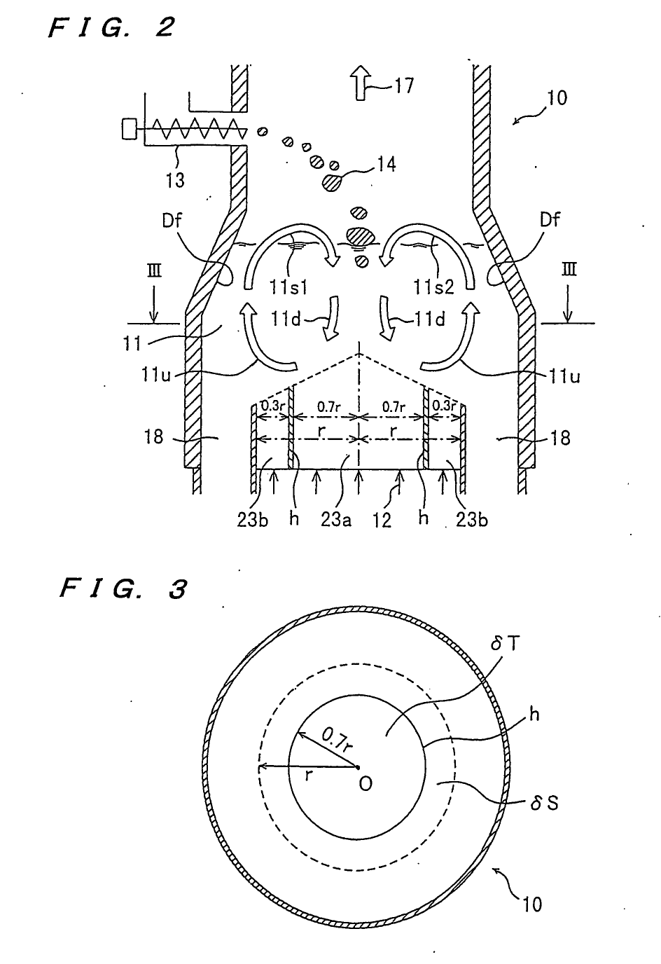

FIGS. 1A through 3 are views showing a general structure of a fluidized-bed gasification furnace for use in a conventional gasification and slagging combustion system. FIG. 1A is a vertical cross-sectional view, and FIG. 1B a cross-sectional view taken along line IB-IB of FIG. 1A. FIG. 2 is an enlarged view of a hearth region shown in FIG. 1A, and FIG. 3 is a cross-sectional view taken along line III-III of FIG. 2.

As shown in FIGS. 1A through 3, the fluidized-bed gasification furnace 10 has a fluidized bed 11, at the lower part thereof, where a fluidized medium such as silica sand is fluidized by a fluidizing gas introduced (i.e. blown) from a bottom of the fluidized-bed gasification furnace 10. In the fluidized bed 11, a circulating flow of a fluidized medium is formed by a descending fluidized bed 11d moving downwardly from the surface toward the furnace bottom, an ascending fluidized bed 11u moving upwardly from the furnace bottom toward the surface, and surface layer flows 11s1, 11s2 flowing toward the central portion of the furnace.

Combustibles 14 are supplied to the fluidized bed 11 from a combustibles supplying port 13 and gasified in the fluidized bed 11 under a reducing atmosphere. Gas and char 17 produced by gasification ascends through the fluidized bed 11 and passes through a freeboard 15, and is introduced into a slagging combustion furnace (combustion fusion furnace) (not shown) through a gas outlet 16. Incombustibles (non-combustibles) such as metals contained in the combustibles 14 are accompanied by the fluidized medium and descend together with the fluidized medium through incombustibles discharging portions 18 provided below the fluidized bed 11 and through chutes Sh, and are then discharged to the outside of the fluidized-bed gasification furnace 10.

As shown in FIG. 1B, the four incombustibles discharging portions 18 communicating with the fluidized bed 11 are provided below the fluidized bed 11 and around the fluidized bed 11. The combustibles 14 are supplied to the central portion of the fluidized bed 11 having a circular horizontal section, and the fluidized medium descends toward the bottom of the gasification furnace 1Q while swallowing the combustibles 14. Then, the fluidized medium reaches the furnace bottom, and disperses together with the combustibles 14 radially outwardly in the circular fluidized bed 11. The combustibles 14 are pyrolyzed in the fluidized medium, and incombustibles included in the combustibles 14 are accompanied by the fluidized medium and are led to the inlet portions of the incombustibles discharging portions 18 which are open at the outer circumference of the circular furnace bottom. The circular furnace bottom is inclined into a conical shape such that the central portion of the furnace bottom is higher than the outer circumferential portion of the furnace bottom. Most of the fluidized medium ascends at the outer circumferential portion of the circular furnace and moves to the central portion of the circular furnace. Thus, spaces 19 formed between the adjacent incombustibles discharging portions 18 and 18 become dead spaces, and hence incombustibles are accumulated in the dead spaces, and the fluidized medium over the dead spaces is stagnated or the descending speed of the fluidized medium becomes sluggish.

Further, the circulating flow of the fluidized medium is liable to be dispersed, and it is difficult for the incombustibles to move smoothly within the circulating flow. When the fluidized medium is dispersed from the central portion to the outer circumferential portion of the furnace bottom, it is difficult to disperse the fluidized medium uniformly. Therefore, incombustibles tend to be deposited in a region where the moving speed of the fluidized medium which moves from the central portion to the outer circumferential portion of the furnace bottom is slower, thus also causing the operation of the fluidized-bed gasification furnace 10 to be hindered.

It has been customary to seal the four incombustibles discharging portions 18 with the so-called “material seal”. If the incombustibles discharging portions 18 are not sufficiently sealed, gas is likely to leak from the incombustibles discharging system. In order to ensure the sealing capability of the incombustibles discharging portions 18, it is necessary for the incombustibles discharging portions 18 to have a given vertical height, and hence the overall furnace (including various devices) is required to have a sufficient height, thus imposing large limitations on the layout of the various devices. In particular, if the inclined chute Sh shown in FIG. 1A is employed, then no sufficient seal effect is achieved, and incombustibles tend to become stagnant in the inclined chute Sh.

The circulating-flow fluidized bed is formed such that a fluidized bed which allows a fluidized medium to ascend actively and a fluidized bed which allows a fluidized medium to descend are generated by supplying respective fluidizing gases at different states, and the fluidized medium rising in the actively ascending fluidized bed reaches the descending fluidized bed, and the descending fluidized bed descends to the furnace bottom, is dispersed, and reaches the region where the active ascending fluidized bed is generated above the furnace bottom. In the circulating-flow fluidized bed thus formed, since a smooth circulating flow needs to be produced, as shown in FIG. 3, it is necessary that the area δT of a fluidizing gas supply device disposed for forming the descending fluidized bed and the area δS of a fluidizing gas supply device disposed for forming the active ascending fluidized bed should be kept at a constant ratio. For example, if the ascending fluidized bed region and the descending fluidized bed region are to have the same areas as each other, then, as shown in FIG. 3, the boundary h between those regions is placed at the position of about 0.7r from the center O as viewed in cross section.

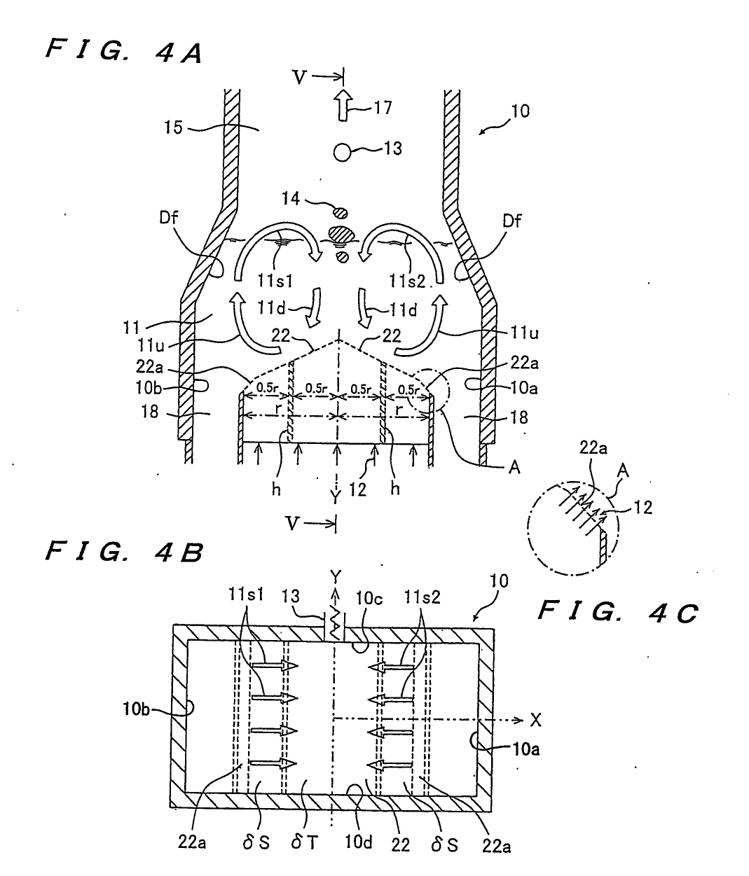

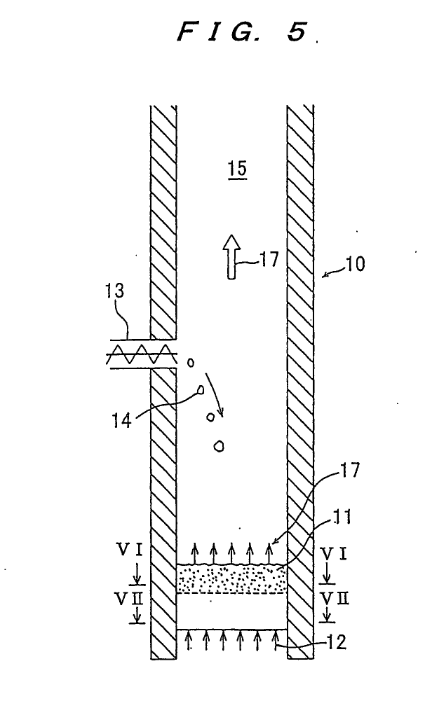

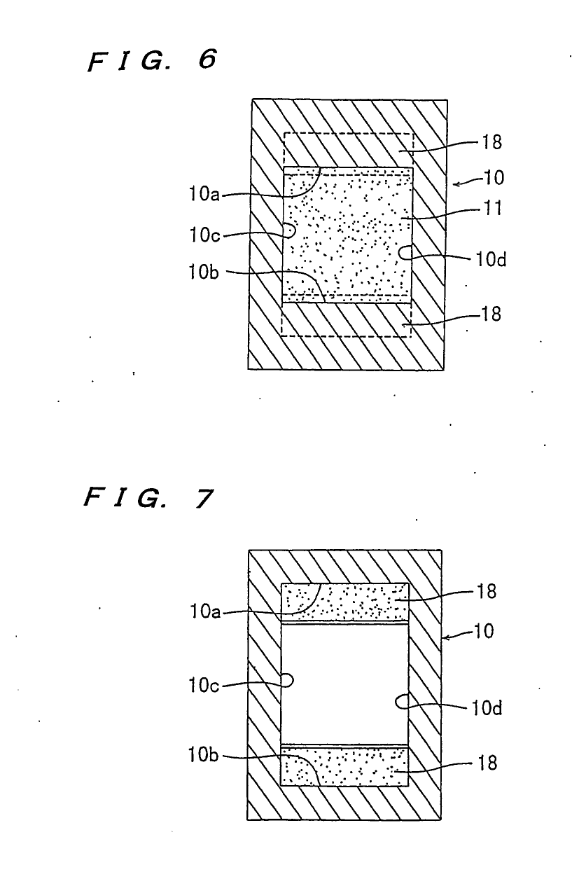

FIGS. 4A through 7 are views showing a general structure of a fluidized-bed gasification furnace according to the present invention. FIG. 4A is a vertical cross-sectional view, FIG. 4B is a horizontal cross-sectional view as viewed from above in FIG. 4A, and FIG. 4C is an enlarged view of a portion A shown in FIG. 4A. FIG. 5 is a cross-sectional view taken along line V-V of FIG. 4A, FIG. 6 is a cross-sectional view taken along line VI-VI of FIG. 5, and FIG. 7 is a cross-sectional view taken along line VII-VII of FIG. 5.

Combustibles 14 such as municipal wastes, industrial wastes, biomass wastes, medical wastes, and automobile wastes such as waste tires or shredder dust are supplied from a combustibles supplying port 13 to a fluidized bed 11 of the fluidized-bed gasification furnace 10. The combustibles 14 are gasified to produce gas and char in the fluidized bed 11 under a reducing atmosphere, and the produced gas 17 ascends through the fluidized bed 11 and passes through a freeboard 15, and is then introduced into a slagging combustion furnace (not shown) through a gas outlet (not shown). Incombustibles such as metals contained in the combustibles 14 are accompanied by an ascending fluidized medium, and are moved downwardly through incombustibles discharging portions 18 provided below the fluidized bed 11, and then discharged from the furnace in the same manner as the fluidized-bed gasification furnace shown in FIGS. 1A and 1B.

The fluidized bed 11 formed in the fluidized-bed gasification furnace 10 has a rectangular horizontal cross section formed by the furnace walls 10a, 10b, 10c and 10d having a rectangular inner surface in horizontal cross section as shown in FIGS. 6 and 7. The incombustibles discharging portions 18 communicating with the fluidized bed 11 are provided at lower parts of a pair of furnace walls 10a and 10b which are oppositely disposed at sides of the fluidized bed 11.

The fluidized medium descends toward a furnace bottom of the gasification furnace 10 while swallowing the combustibles 14 supplied to the gasification furnace and being accompanied by the descending fluidized bed 11d. After the fluidized medium reaches the furnace bottom, the fluidized medium disperses in the directions of the opposite furnace walls 10a and 10b. The combustibles 14 are pyrolyzed in the fluidized medium, and incombustibles included in the combustibles 14 are accompanied by the fluidized medium and introduced into the inlets of the incombustibles discharging portions 18 which are open at the lower parts of the furnace walls 10a and 10b. The furnace bottom is inclined such that a region where the combustibles 14 are swallowed by the fluidized medium is higher than the inlets of the incombustibles discharging portions 18. Most of the fluidized medium ascends as an ascending fluidized bed 11u that ascends at the opposite end portions of the hearth, and is guided by inwardly inclined portions of the furnace wall surfaces 10a and 10b, i.e. deflectors Df and Df to move as surface layer flows 11s1 and 11s2 toward the central part of the furnace.

In this embodiment, the incombustibles discharging portions 18 communicating with the fluidized bed 11 are provided at the lower parts of the furnace walls 10a and 10b, and have respective rectangular inlets whose long sides are substantially equal to widths of the furnace walls 10a and 10b. Therefore, unlike the conventional fluidized-bed gasification furnace shown in FIGS. 1A through 3, there is no dead space where the fluidized medium is stagnated or the descending speed of the fluidizing medium is sluggish over the space 19 (see FIG. 1B) between the incombustibles discharging portions 18 in the fluidized-bed gasification furnace 10 shown in FIGS. 6 and 7.

The furnace bottom 22 has end portions 22a inclined at a sharp gradient (at an angle of 45 degrees or more), and a fluidizing gas 12 is also blown in from the inclined end portions 22a. Because the fluidized medium flows in the vicinity of the end portions 22a due to the fluidizing gas 12 that is blown in from the inclined end portions 22a, the incombustibles that have reached the end portions of the furnace bottom are smoothly guided to the incombustibles discharging portions 18. If the end portions of the furnace bottom 22 were not inclined at a sharp gradient in the fluidized bed which has a substantially rectangular horizontal cross section, the incombustibles would be guided together with the fluidized medium along the gradient of the furnace bottom 22 by the circulating flow. Since the fluidized medium is present as a fixed bed in the incombustibles discharging portions 18, the incombustibles may be accumulated at the end portions that are connected to the incombustibles discharging portions 18 at the furnace bottom.

Inasmuch as the horizontal cross section of the furnace is substantially rectangular, a circulating flow of the fluidized medium is formed so as not to disperse the fluidized medium from the location near the furnace bottom where the waste materials have been swallowed toward the inlets of the incombustibles discharging portions 18, and a gravity action is applied to the fluidized medium containing incombustibles due to the inclined surfaces of the furnace bottom. Consequently, the incombustibles are guided to the incombustibles discharging portions 18 by the flow of the fluidized medium without being deposited on the furnace bottom.

Furthermore, because the seal of the chute communicating with the incombustibles discharging portions 18 is effective only in a region which is densely filled with the fluidized medium, if the chute is obliquely disposed as with the conventional arrangement, then the height of the chute would need to be increased to ensure its vertical height in order to provide a sufficient seal.

In order to compare the fluidized-bed gasification furnace according to the present invention with the conventional fluidized-bed gasification furnace, the both of the gasification furnaces are arranged to have the same circulating flow. However, since the gasification furnace according to the present invention has the rectangular horizontal section, the direction of the circulating flow of the fluidized medium may be reversed such that the fluidized medium may descend at the sides of the furnace walls 10a and 10b which are oppositely disposed and ascend at the central portion of the gasification furnace 10. In this case, an incombustibles discharging portion having an inlet whose long side is substantially equal to each of sides of the furnace walls 10a and 10b may easily be provided at the central portion of the furnace bottom.

Next, a gasification furnace suitable for use in a gasification and slagging combustion system (gasification and ash-melting system) which can treat a large quantity of wastes, i.e. has a processing capacity of 150 tons per day or more, particularly 200 to 400 tons per day will be described below.

One of the features of large-scale fluidized-bed gasification furnace is that the descending fluidized bed is brought in contact with the furnace wall at a certain portion, and a waste supply device or a waste supply port for supplying wastes into the gasification furnace is provided in the furnace wall at a location immediately above the certain portion.

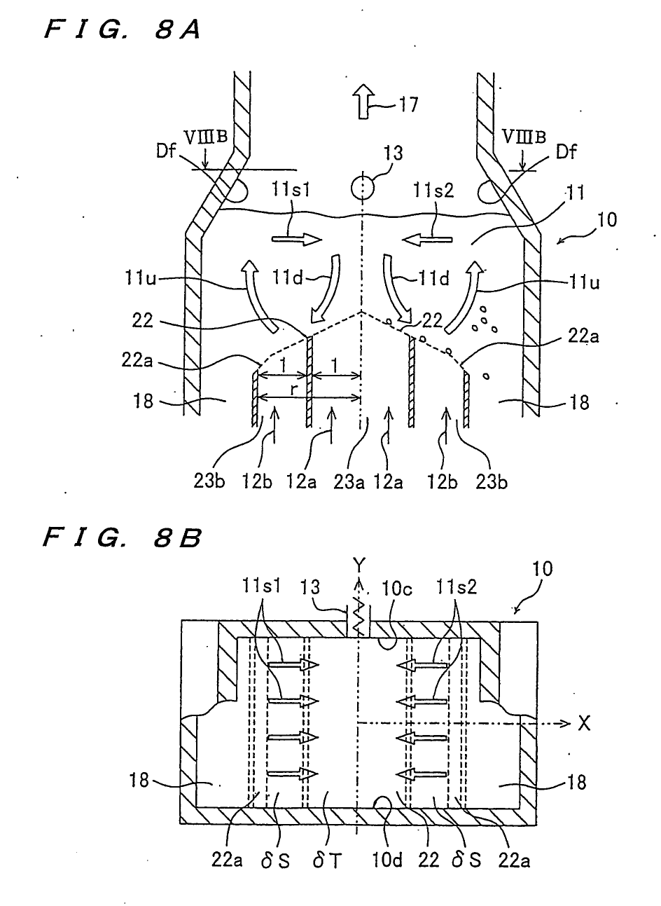

A large-scale fluidized-bed gasification furnace having the above features will be described below with reference to FIGS. 8A and 8B. FIG. 8A is a vertical cross-sectional view showing a general structure of a fluidized-bed gasification furnace according to the present invention, and FIG. 8B is a cross-sectional view taken along line VIIIB-VIIIB of FIG. 8A.

The fluidized-bed gasification furnace has a substantially rectangular horizontal cross section. A descending fluidized bed 11d is formed centrally in the furnace, and active ascending fluidized beds 11u are formed in opposite sides of the furnace. In order to form these fluidized beds, wind boxes 23a, 23b, 23b for supplying fluidizing gases are disposed below a fluidized-bed furnace bottom 22. The wind boxes 23b, 23b for forming the active ascending fluidized bed 11u and the wind box 23a for forming the descending fluidized bed 11d are divided from each other. Alternatively, there is provided a fluidizing gas supply device having holes which are formed in the furnace bottom 22 for supplying fluidizing gases, and have a diameter or a pitch between adjacent holes optimally selected to differentiate the mass velocities of fluidizing gases corresponding to the respective regions.

It is important to keep the hearth area ratio of the regions that correspond respectively to the descending fluidized bed 11d and the active ascending fluidized bed 11u, within a predetermined range. This hearth area ratio is approximately 1 to 1. If the hearth area ratio is greatly different from 1 to 1, then a circulating flow for circulating the fluidized medium as an entire fluidized bed in the furnace while keeping fluidization of the fluidized medium will not be produced. From this standpoint, it is necessary for the conventional cylindrical fluidized-bed furnace (see FIGS. 1A through 3) to form the descending fluidized bed 11d within an inner circular region at the position of about 0.7 of the radius 1 from the center of the circle to the outer periphery of the furnace bottom, and to form the active ascending fluidized bed 11u in an outer circular region between the positions 0.7 and 1.0 in the distance from the center of the circle to the outer periphery of the furnace bottom, in order to keep the hearth area ratio of the regions that correspond respectively to the descending fluidized bed and the active ascending fluidized bed, approximately 1 to 1, for example.

According to the present invention, however, since the horizontal cross section of the furnace is substantially rectangular, in order to keep the hearth area ratio of the regions that correspond respectively to the descending fluidized bed 11d and the active ascending fluidized bed 11u, approximately 1 to 1, a descending fluidized bed may be formed within an inner rectangular region up to the position of about 0.5 of the distance r from the center of the furnace to the outer periphery of the furnace bottom, and an active ascending fluidized bed 11u may be formed in an outer rectangular region from the position of about 0.5r to the position of about 1.0r. This arrangement makes a decisive difference as to the gasification process if the amount of char and incombustibles contained in the charged combustibles is large.

Specifically, in the case where a comparison between a furnace having a substantially rectangular horizontal cross section and a furnace having a substantially circular horizontal cross section which operate under the same conditions including the quality of combustibles, and the like is made, the charged combustibles do not move in the active ascending fluidized bed over a sufficient distance, and hence the char is not sufficiently disintegrated in the fluidized bed of the furnace having the circular cross section. On the other hand, the charged combustibles move in the active ascending fluidized bed over a sufficient distance, and hence the char is sufficiently disintegrated in the fluidized bed 11 of the furnace having the rectangular cross section.

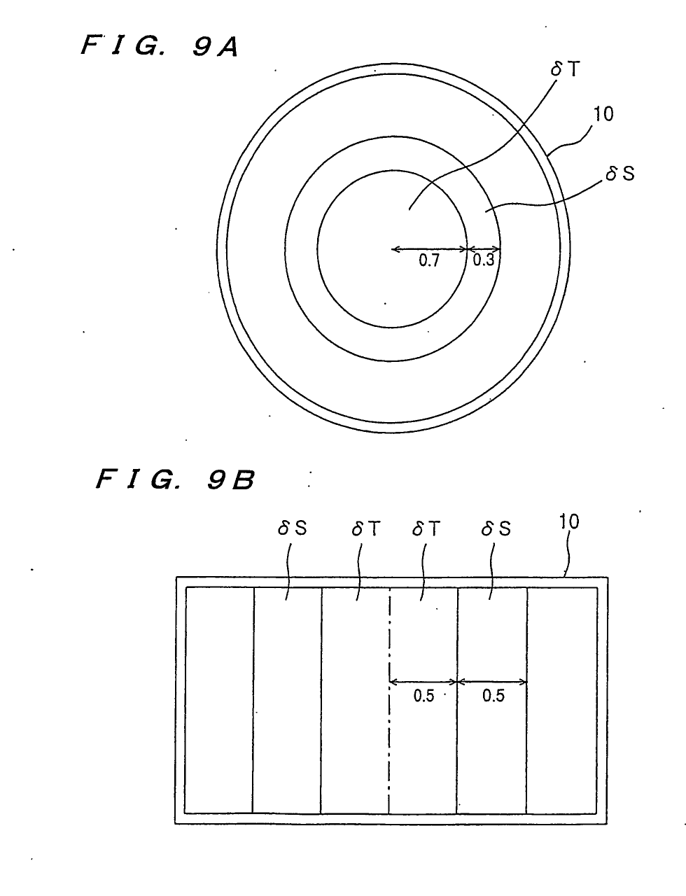

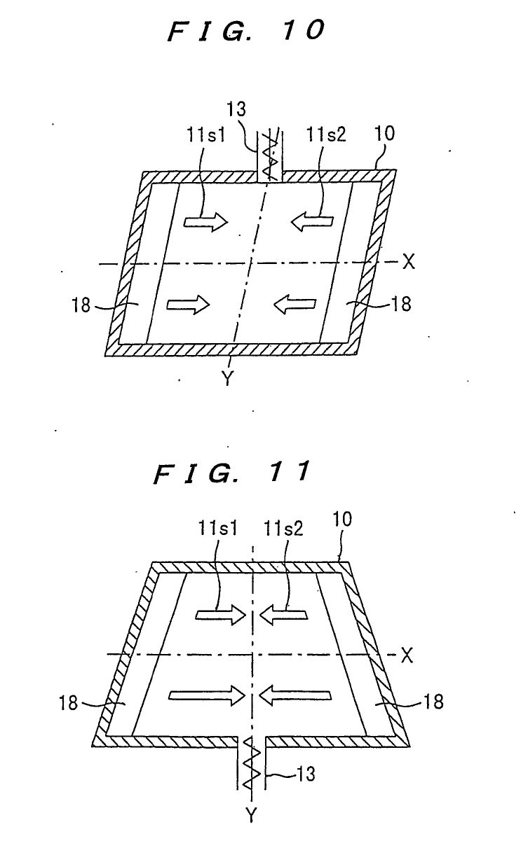

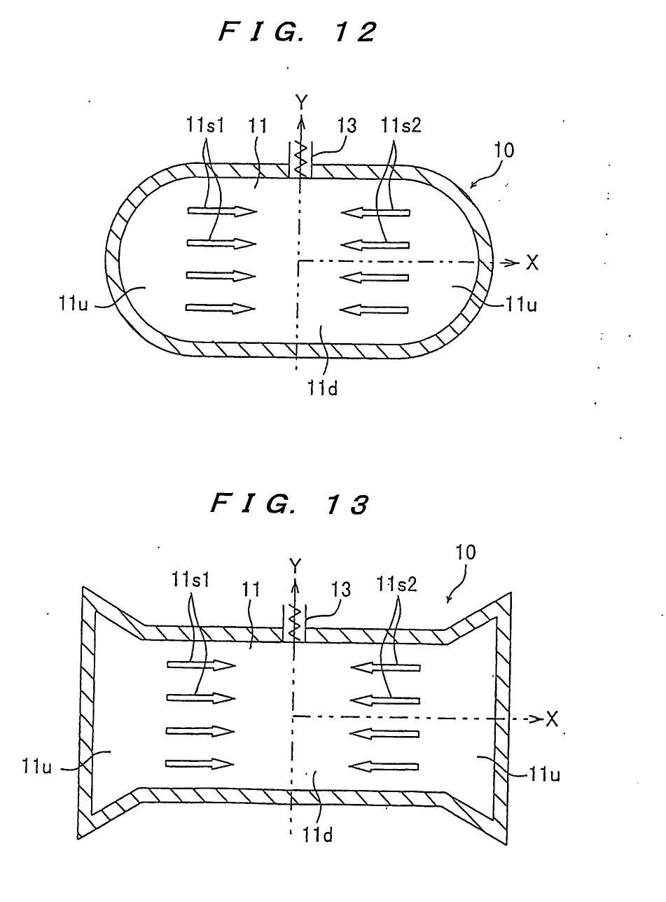

The difference between the furnace configurations also make a decisive difference as to a classifying ability to separate the incombustibles and the fluidized medium from the char in the fluidized bed 11. In the case where a comparison between a furnace having a substantially rectangular horizontal cross section and a furnace having a substantially circular horizontal cross section which operate under the same conditions including the quality of combustibles, such as waste materials, and the like is made, the combustibles do not move in the active ascending fluidized bed over a sufficient distance (see the location δS (0.3) corresponding to the ascending fluidized bed in FIG. 9A), and hence the classifying ability (separating ability) to separate the incombustibles and the fluidized medium from the char is not sufficient in the fluidized bed of the furnace having the circular cross section. On the other hand, the charged combustibles move in the active ascending fluidized bed over a sufficient distance (see the location δS (0.5) corresponding to the ascending fluidized bed in FIG. 9B), and hence the incombustibles and the fluidized medium are sufficiently classified or separated from the char in the fluidized bed of the furnace having the rectangular cross section.

By constructing the incombustibles discharging chute into a vertical straight shape, the incombustibles discharging chute can be sealed sufficiently. Almost no char is present in the incombustibles discharging chute because of the classifying ability of char by the active ascending fluidized bed. Therefore, the generation of clinker in the incombustibles discharging chute can effectively be suppressed.

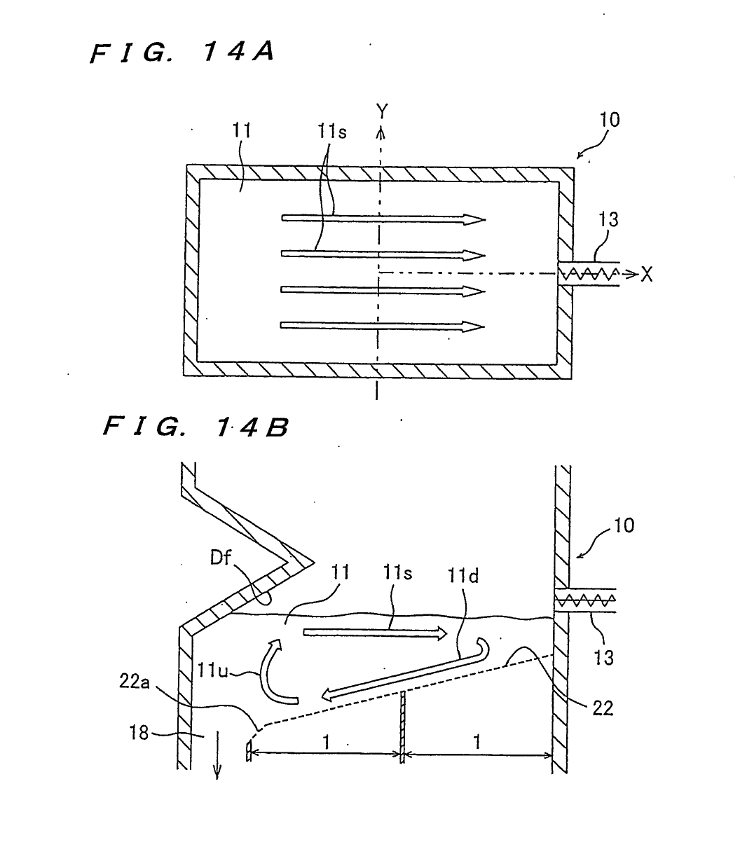

In the above arrangement, the descending fluidized bed 11d is provided in the inner region of the fluidized bed 11, and the active ascending fluidized bed 11u is provided in the outer region of the fluidized bed 11. However, the active ascending fluidized bed 11u may be provided in the inner region of the fluidized bed 11, and the descending fluidized bed 11d may be provided in the outer region of the fluidized bed 11. The horizontal cross section of the furnace may not be substantially rectangular, but may be slightly modified such that the distance ratio of the regions in the hearth which correspond to the descending fluidized bed and the ascending fluidized bed with respect to the center of the furnace may be in the range from about 0.4 to about 0.6. With such a modification, the horizontal cross section of the furnace may be a polygonal shape such as a substantial rhombus, a substantial parallelogram, a substantial triangle, a substantial elongate rectangle, or the like. FIG. 10 shows a furnace whose horizontal cross section is a substantial parallelogram, and FIG. 11 shows a furnace whose horizontal cross section is substantially trapezoidal.

If a furnace having a circular horizontal cross section is simply increased in scale, then the distance in the radially outward direction needs to be extended throughout the overall furnace. In this case, since the depth of the fluidized bed at the positions of the incombustibles discharging portions in the hearth is simply increased, the required pressure of the fluidizing air at the positions of the incombustibles discharging portions is very large. In the case of the furnace having a rectangular horizontal cross section, however, if the furnace is increased in scale, it is possible to extend the length from the center of the furnace in a longitudinal direction while keeping the length from the center of the furnace constant in a lateral direction. Thus, the furnace can be increased in scale without changing the depth of the fluidized bed 11.

The fluidized-bed gasification furnace will be described below with reference to FIGS. 8A and 8B. As shown in FIG. 8A, the fluidized medium ascends in the active ascending fluidized bed 11u in the opposite sides of the furnace, and moves as surface layer flows 11s1, 11s2 to the descending fluidized bed 11d. As shown in FIG. 8B, the surface layer flows which enter the descending fluidized bed move in only two directions that face each other, i.e., the direction (X direction) of the surface layer flow 11s1, and the direction (−X direction) of the surface layer flow 11s2. There is no substantial flow in the Y direction or the −Y direction.

Because of the above features, there is no substantial surface layer flow entering the descending fluidized bed 11d in the Y direction or the −Y direction, and by simply keeping the furnace dimensions in the X direction and changing the furnace dimensions in the Y direction to cope with an increase in the amount of combustibles to be processed, the range δS in which the fluidizing gas supply device for forming an active ascending fluidized bed is positioned can be linearly proportional to the dimensions in the Y direction. That is, the descending fluidized bed and the active ascending fluidized bed which can be expanded and contracted in the Y direction are prevented from being misaligned at their boundary. Specifically, the ratio at the boundary between the descending fluidized bed 11d and the active ascending fluidized bed 11u does not have to be changed, the air ratio of air supplied to the active ascending fluidized bed 11u does not have to be changed, and the flow velocity of air supplied to the active ascending fluidized bed 11u does not have to be changed. Therefore, the furnace can be increased in scale with ease.

While the combustibles descend in the descending fluidized bed 11d, the combustibles are pyrolyzed and partially oxidized by the heat of the fluidized medium and a small amount of fluidizing air, thus gradually producing pyrolysis gas, char (solid carbon), tar, and ash. The char is carried from the descending fluidized bed 11d along the inclined surface of the furnace bottom to the active ascending fluidized bed 11u under the pressure of the moving fluidized medium. A fluidizing gas 12b that is supplied to form the active ascending fluidized bed 11u is greater in quantity than a fluidizing gas 12a that is supplied to form the descending fluidizing bed 11d.

Therefore, the solid carbon (char) which has been carried from the descending fluidized bed 11d reacts with oxygen and is partially combusted (burned), thus generating heat. By this heat of combustion, the fluidized medium is kept in a temperature ranging from 400° C. to 800° C. (preferably from 450° C. to 650° C.). In the active ascending fluidized bed 11u, the char is partially combusted and changed into fine particles. In the active ascending fluidized bed 11u, the char ascends, and in the fluidized bed on the sharply inclined surfaces of the end portions 22b, the char is classified. The incombustibles are smoothly discharged together with the fluidized medium from the incombustibles discharging portions 18 through the incombustible discharging chute to the outside of the furnace. The ascending fluidized bed 11u moves as the surface layer flows 11s1, 11s2 toward the descending fluidized bed 1d. The particulate char in the surface layer flows 11s1, 11s2 is drawn in air flow and released from the surface of the fluidized bed, and is carried by the flow of produced gas 17 into the slagging combustion furnace.

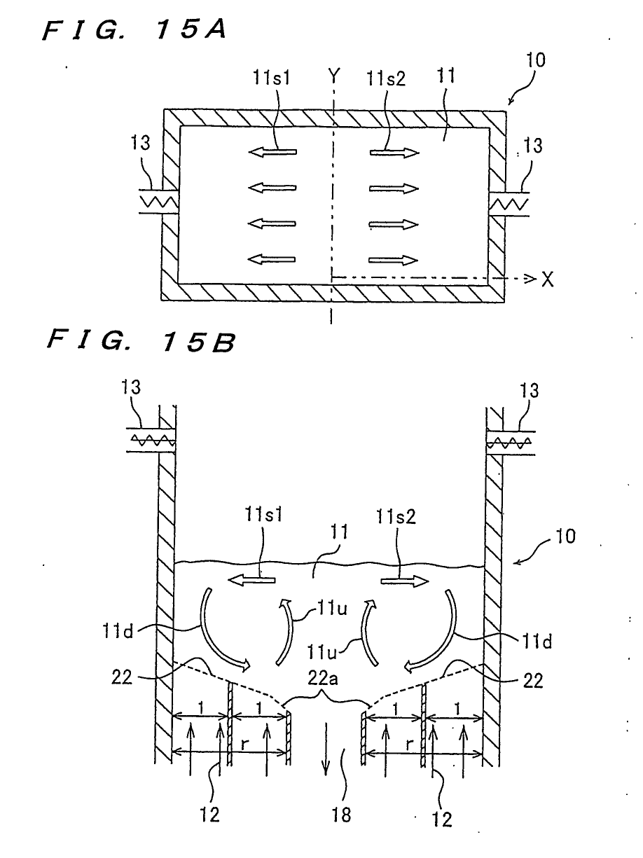

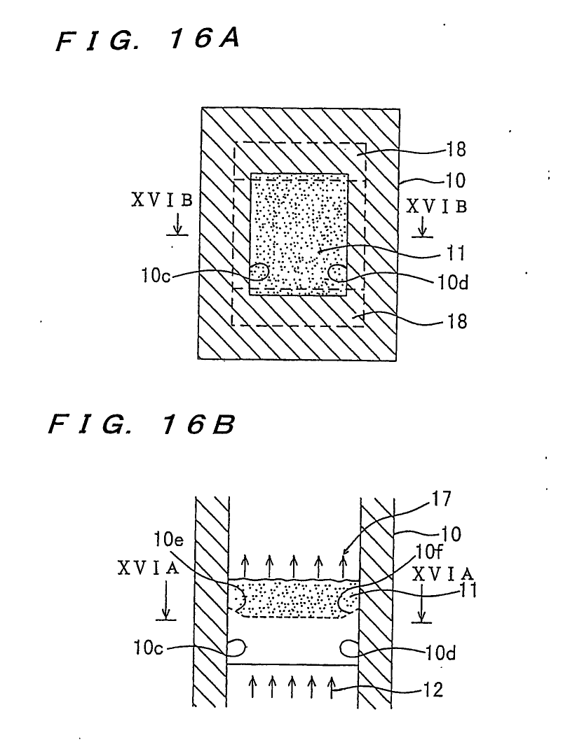

In the slagging combustion furnace, the produced gas 17 and the particulate char supplied from the fluidized-bed gasification furnace 10 are combusted as a fuel at a high temperature by oxygen or air or oxygen-enriched air, thus melting ash, and the like. In FIGS. 8A and 8B, the fluidized-bed gasification furnace has a rectangular horizontal cross section. The structures shown in FIGS. 10, 11, 12, and 13 may be employed as embodiments of the present invention. Specifically, a structure for causing the surface layer flows 11s1, 11s2 of the fluidized medium which has ascended with the active ascending fluidized bed 11u to move only in a direction, an opposite direction, or both of the directions, i.e., the X direction, the −X direction, or the X and −X directions, to the substantially descending fluidized bed 11d, is not limited to a rectangular structure.

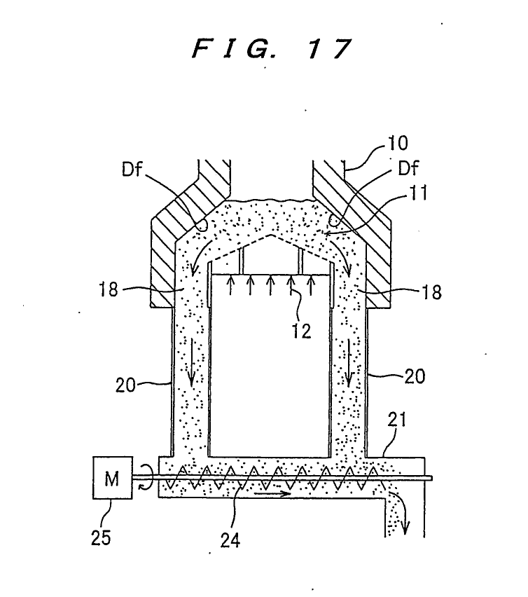

According to the structure of a fluidized-bed gasification furnace which is shown in horizontal cross section in FIG. 14A and vertical cross section in FIG. 14B, surface layer flows 11s directed toward the descending fluidized beds 11d are oriented only in the X direction. According to the structure of a fluidized-bed gasification furnace which is shown in horizontal cross section in FIG. 15A and vertical cross section in FIG. 15B, the descending fluidized beds 11d are positioned at the opposite end portions of the furnace, and surface layer flows 11s1, 11s2 directed toward the descending fluidized beds 11d are oriented in the X direction or the −X direction, and no substantial flows are present in the Y direction or the −Y direction.

In FIG. 6, the facing furnace wall surfaces 10c, 10d with no incombustibles discharging portions 18, 18 disposed below the fluidized bed 11 are parallel to each other. However, as shown in FIG. 16A which is a cross-sectional view (corresponding to the cross-sectional view taken along line VI-VI of FIG. 5) taken along line XVIA-XVIA of FIG. 16B, and FIG. 16B which is a cross-sectional view taken along line XVIB-XVIB of FIG. 16A, the opposite furnace walls 10c and 10d may project toward the center of the fluidized bed 11 so as to form inclined surfaces 10e and 10f which incline downwardly toward the fluidized bed 11. Since the inclined surfaces 10e and 10f are provided by the opposite furnace walls 10c and 10d projecting toward the center of the fluidized bed 11, the fluidized medium which descends in the fluidized bed 11 can smoothly be moved toward the incombustibles discharging portions 18. Thus, the incombustibles can be prevented from being deposited in the vicinity of the furnace walls 10c and 10d of the furnace bottom.

FIG. 17 is a schematic structural view showing an incombustibles discharging section for discharging a fluidized medium and incombustibles through a pair of incombustibles discharging portions.

As shown in FIG. 17, vertical chutes 20 and 20 having a predetermined length which are connected to lower ends of a pair of opposite incombustibles discharging portions 18 and 18 are disposed substantially vertically, and the lower ends of the vertical chutes 20 and 20 are connected to an incombustibles discharging device 21. A screw conveyer 24 is disposed in the incombustibles discharging device 21 and is coupled to a motor 25. By energizing the motor 25, the fluidized medium and incombustibles discharged from the pair of the incombustibles discharging portions 18 and 18 pass through the vertical chutes 20 and 20, and are joined together in the incombustibles discharging device 21, and then discharged. Here, the vertical chutes 20 and 20 disposed substantially vertically means that the vertical chutes 20 and 20 are disposed in a direction which is substantially perpendicular to the horizontal.

Since the vertical chutes 20 and 20 having a predetermined length which are connected to the lower ends of the pair of the opposite incombustibles discharging portions 18 and 18 are provided vertically, the vertical chutes 20 and 20 are filled with the fluidized medium densely, and hence a material sealing action performed by such fluidized medium can prevent the leakage of the fluidizing gas (mainly air) 12 through the incombustibles discharging portions 18 and 18.

Furthermore, since the pair of the vertical chutes 20 and 20 connected to the lower ends of the respective incombustibles discharging portions 18 and 18 are disposed vertically, and the incombustibles discharging device 21 for joining the fluidized medium and the incombustibles discharged from the both of the incombustibles discharging portions 18 and 18 and discharging them therefrom is connected to the lower ends of the vertical chutes 20 and 20, the vertical chutes 20 and 20 and the incombustibles discharging device 21 have a simpler structure than those of the conventional fluidized-bed gasification furnace having four incombustibles discharging portions as shown in FIGS. 1A and 1B, and can easily be installed.

The incombustibles discharging portions 18 and 18 and the vertical chutes 20 and 20 have a constant horizontal section from the inlets of the incombustibles discharging portions 18 and 18 to locations close to a mechanical discharging device such as the screw conveyer 24. That is, the incombustibles discharging portions 18 and 18 and the vertical chutes 20 and 20 are neither enlarged nor reduced in area in the direction in which the fluidized medium flows down. Therefore, a void space is hardly formed in the incombustibles discharging portions 18 and 18 and the vertical chutes 20 and 20, and hence a tight material seal can be performed. The horizontal cross sections of the vertical chutes 20, 20 may possibly be slightly different between their upper and lower regions because the vertical chutes 20, 20 may actually have different shapes in their upper regions (near the gasification furnace) and their lower regions (near the screw conveyor) due to connections to be made by the upper and lower regions of the vertical chutes 20, 20. The vertical chutes 20, 20 have a predetermined length (e.g., about 2.0 m or more, or preferably about 2.5 m), and are disposed substantially vertically so as to communicate with the incombustibles discharging portions.

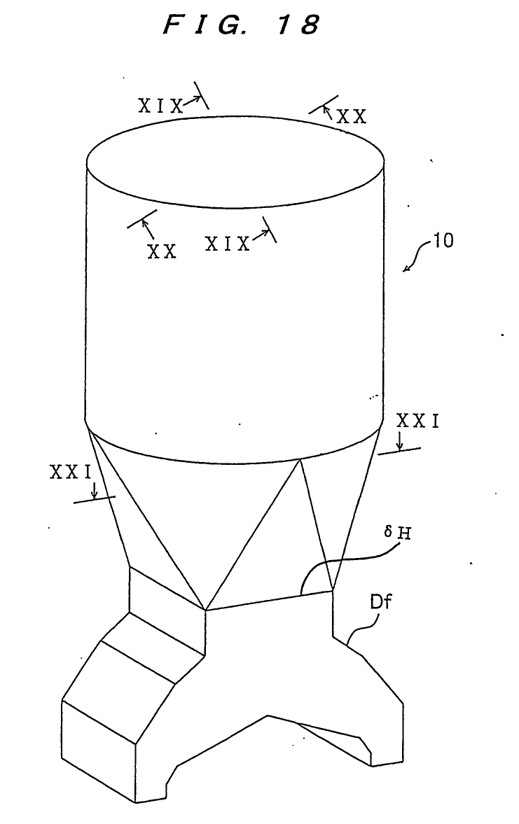

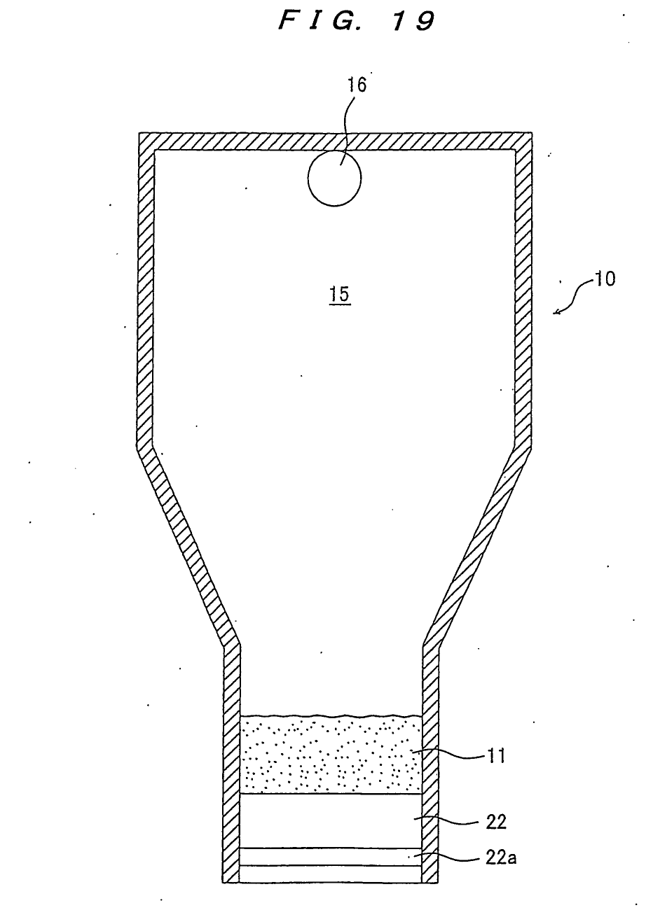

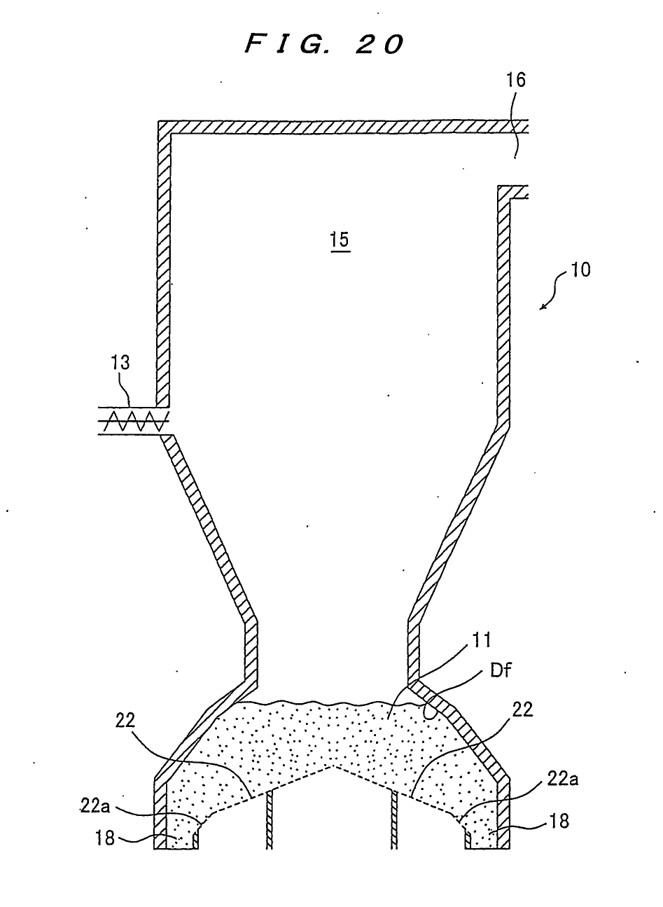

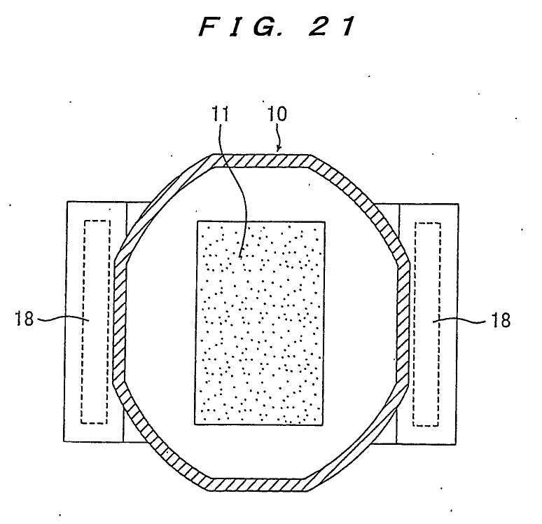

FIGS. 18 through 21 show structures of a fluidized-bed gasification furnace according to the present invention. FIG. 18 is a perspective view showing an appearance, FIG. 19 is a cross-sectional view taken along line XIX-XIX of FIG. 18, FIG. 20 is a cross-sectional view taken along line XX-XX of FIG. 18, and FIG. 21 is a cross-sectional view taken along line XXI-XXI of FIG. 18. As shown in FIGS. 18 through 21, a fluidized-bed gasification furnace 10 has a hearth having a substantially rectangular horizontal cross-sectional area which is reduced down to a deflector Df. The horizontal cross section is changed from the rectangular shape to a circular shape in a portion 8H where a freeboard 15 above the deflector Df has an increased cross section.

As described above, the freeboard 15 of the fluidized-bed gasification furnace 10 has a function to separate pyrolysis gas, char and ash, and the fluidized medium that are blown upwardly from the fluidized bed 11, and deliver the pyrolysis gas, char and ash to a slagging combustion furnace at a subsequent stage. Therefore, the freeboard 15 has a cross-sectional area for setting the flow velocity in a predetermined range, and needs to have a sufficient height for preventing the fluidized medium from being scattered. Thus, the freeboard 15 of the fluidized-bed gasification furnace 10 is required to have a certain size, and has its inner surface made of a refractory material because of high operating temperature range. In order for the freeboard 15 which defines a space free of contents to have structural strength, it should have a substantially circular horizontal cross section.

Because of the substantially circular horizontal cross section, any reinforcing members required by the freeboard 15 can greatly be reduced. If the freeboard 15 has a rectangular horizontal cross section, then stresses tend to concentrate on corners of the freeboard 15 due to thermal expansion of the refractory material, thus causing the refractory material to be damaged or project from the wall surface. However, the freeboard 15 which is of a substantially circular horizontal cross section greatly prolongs the service life of the refractory material and greatly reduces expenses for repairing the refractory material.

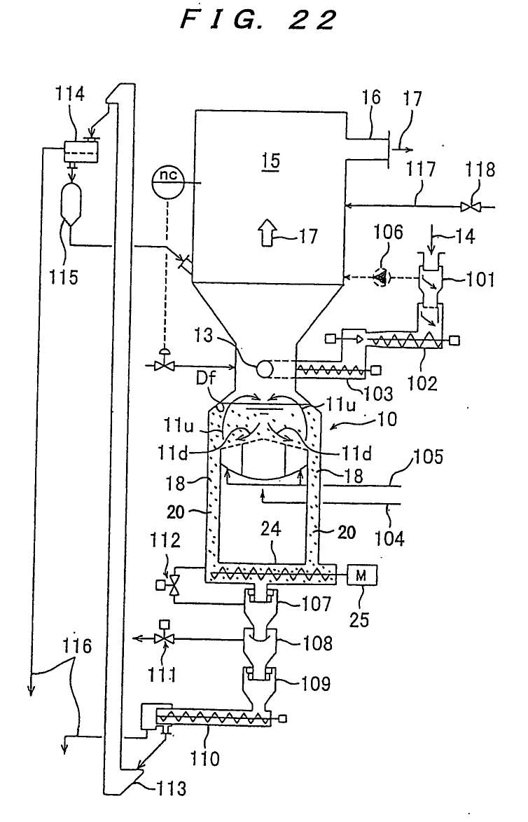

FIG. 22 is a schematic view showing an arrangement of a gasification apparatus having a fluidized-bed gasification furnace according to the present invention. Materials, to be gasified, comprising combustibles 14 such as wastes are supplied from a double damper 101, a constant feeder 102, and a waste feeder 103 to a fluidized-bed gasification furnace 10 according to the present invention. The constant feeder 102 is capable of sealing the pressure in the furnace according to a material sealing effect provided by the materials to be gasified. The materials to be gasified are delivered by the waste feeder 103 into the fluidized-bed gasification furnace 10.

The gasification apparatus of the above structure is supplied with a fluidizing gas 104 and a fluidizing gas 105. These fluidizing gases are selected from steam, air, oxygen, a mixed gas of steam and air, a mixed gas of oxygen and air, and a mixture of all these gases.

A blower 106 communicates with the double damper 101 and a freeboard 15 of the fluidized-bed gasification furnace 10. If the materials to be gasified are not sufficiently compressed, then the blower 106 returns a gas that has leaked from the fluidized-bed gasification furnace 10 through the constant feeder 102 into the double damper 101, to the interior of the furnace. The blower 106 may be positioned to feed the gas from the double damper 101 to the freeboard 15 in the furnace for drawing a suitable amount of air and gas from the double damper 101 and returning them into the furnace so that the atmospheric pressure will be developed in an upper part of the double damper 101.

For discharging incombustibles from the fluidized-bed gasification furnace 10, incombustibles discharging portions 18, 18, vertical chutes 20, 20, a constant discharger comprising a screw conveyor 24, a first sealing swing valve 107, a swing cutting valve 108, a second sealing swing valve 109, and a continuous discharger 110 with a trommel are successively arranged, and are operated as follows:

(1) The first sealing swing valve 107 is opened, and the second sealing swing valve 109 is closed to seal the pressure in the fluidized-bed gasification furnace 10 by the second sealing swing valve 109. The constant discharger is operated to actuate the screw conveyor 24 with the motor 25 for discharging incombustibles including a fluidized medium (sand, etc.) from the chute to the swing cutting valve 108.

(2) When the swing cutting valve 108 receives a predetermined amount of incombustibles, the constant discharger is turned off, and the first sealing swing valve 107 is closed to seal the pressure in the fluidized-bed gasification furnace 10 by the first sealing swing valve 107. Then, a discharge valve 111 is opened to return the atmospheric pressure back in the swing cutting valve 108. Then, the second sealing swing valve 109 is fully opened, and the swing cutting valve 108 is opened for discharging the incombustibles into the continuous discharger 110 with the trommel.

(3) After the second sealing swing valve 109 is fully closed, an equalizing valve 112 is opened to equalize the pressure in the first sealing swing valve 107 and the pressure in the chute. Thereafter, the first sealing swing valve 107 is opened, and then the operation goes back to the first step (1). These steps (1) through (3) are automatically repeated.

The continuous discharger 110 with the trommel is continuously operated to discharge large-size incombustibles out of the system. Sand and small-size incombustibles are transported by a sand circulating elevator 113. After fine incombustibles are removed by a classifier 114, the fluidized medium is returned through a sealing mechanism 115 to the fluidized-bed gasification furnace 10. The continuous discharger 110 with the trommel may be replaced with a vibrating screen for discharging large-size incombustibles out of the system. With the incombustibles discharging mechanism as described above, since the two sealing swing valves 107, 109 have only a pressure sealing function without receiving incombustibles, incombustibles are prevented from being trapped in the seal portions of the first and second sealing swing valves. If the pressure in the furnace may be slightly negative, then the sealing function of the valves may be unnecessary.

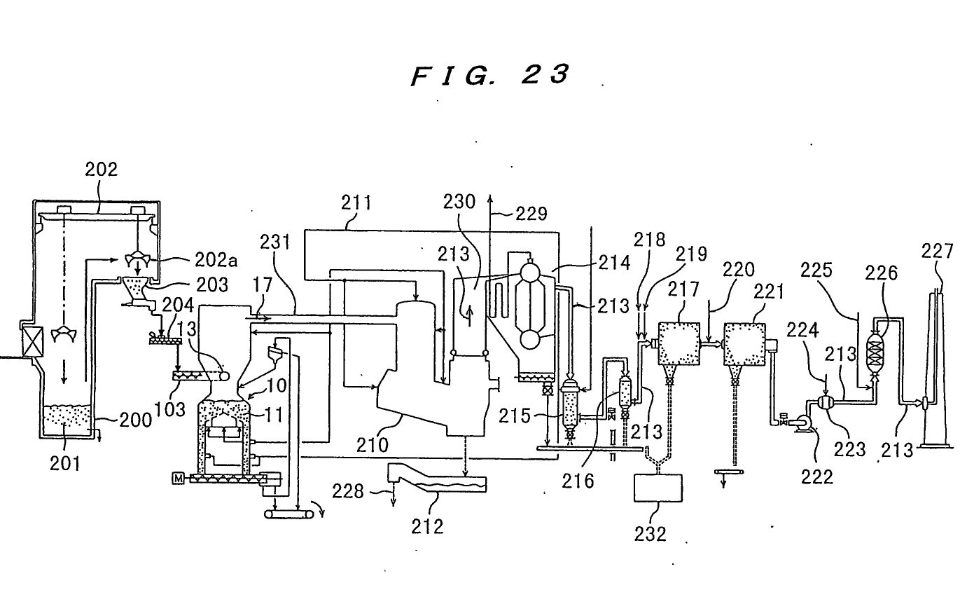

FIG. 23 is a view showing an arrangement of a gasification and slagging combustion system which incorporates a fluidized-bed gasification furnace according to the present invention. Wastes 201 from a waste pit 200 are held by a bucket 202a of a waste crane 202, and charged into a waste hopper 203. The wastes 201 in the waste hopper 203 are supplied by a waste supply device 204 to a waste feeder 103 of a fluidized-bed gasification furnace 10, and are then charged into the fluidized-bed gasification furnace 10 from a combustibles supplying port 13. The wastes 201 are pyrolyzed into a gas in a fluidized bed 11 in the fluidized-bed gasification furnace 10. Produced gas 17 and fine particles (ash, char, etc.) are introduced together through a conduit 231 into a slagging combustion furnace 210, and the ash is melted into molten slag by combustion of the produced gas 17 and the fine particles.

In the gasification and slagging combustion system shown in FIG. 23, the produced gas 17 containing a large amount of combustible components, which has been produced in the fluidized-bed gasification furnace 10, is introduced into the slagging combustion furnace 210. Oxygen, a mixed gas of oxygen and air, air, or a mixed gas of steam and at least oxygen represented by reference numeral 211 is blown into the slagging combustion furnace 210 to combust the produced gas 17 and the fine particles at a temperature of about 1300° C. or higher, thus generating heat to melt the ash and decompose harmful substances including dioxin, PCB, etc. The ash is melted into molten slag in the slagging combustion furnace 210, and the molten slag is trapped by the furnace wall under centrifugal forces created by swirling flows in the slagging combustion furnace. The trapped molten slag flows down to the furnace bottom, and is quenched in a water tank 212 with a slag conveyor, and then discharged as slag 228 by the slag conveyor.

Exhaust gas 213 is separated from the slag in the slagging combustion furnace 210 and then discharged. Then, the exhaust gas 213 is introduced into a waste heat boiler 214 to recover stream 229, and passes through a secondary air preheater 215 and an economizer 216 in which heat of the exhaust gas 213 is recovered. Activated carbon 218 and dedusting agent 219 are added to the exhaust gas 213 that is discharged from the economizer 216. Thereafter, the exhaust gas 213 is introduced into a first dust collector 217 that removes dust particles from the exhaust gas 213. Then, slaked lime 220 is added to the exhaust gas 213, and then the exhaust gas 213 is introduced into a second dust collector 221 that removes dust particles resulted from acid gas components. The exhaust gas 213 is then drawn by an air drafter 222 into an exhaust gas reheater 223 in which the exhaust gas 213 is reheated with steam 224 that is introduced into the exhaust gas reheater 223. Ammonia gas 225 is added to the heated exhaust gas 213, and the exhaust gas containing ammonia gas is then introduced into a catalytic column 226 which denitrates the exhaust gas 213. The exhaust gas 213 from which the harmful substances have been removed is then discharged from a stack 227 into the atmosphere.

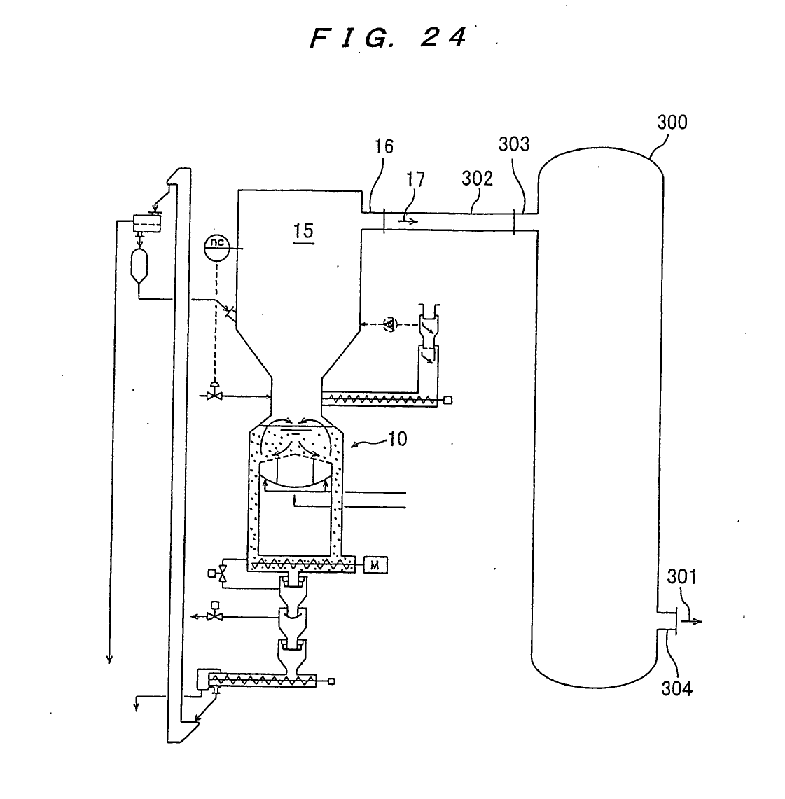

Next, a gasification and reforming apparatus which incorporates a fluidized-bed gasification furnace according to the present invention will be described below. FIG. 24 is a schematic view showing an arrangement of a gasification and reforming apparatus which incorporates the fluidized-bed gasification furnace shown in FIG. 20. Combustible produced gas 17 and fine particles that are produced in a fluidized-bed gasification furnace 10 pass through a gas outlet 16 and a conduit 302, and are introduced from a gas inlet 303 into a reforming furnace 300. In the reforming furnace 300, the combustible produced gas 17 and the fine particles are reformed into a reformed gas 301, which is discharged from a gas outlet 304. The reforming furnace 300 or a catalystic reformer (e.g., a catalytic fluidized-bed furnace) may be selected as the reforming apparatus, and either may be selected depending on the properties of the material to be processed which is introduced into the fluidized-bed gasification furnace 10.

For example, if a material containing a lot of slag sources is to be processed, then it is preferable to select an apparatus capable of removing slag such as the reforming furnace 300. If biomass containing almost no slag sources is to be processed, then it is preferable to select the catalystic reformer. A heat recovery device (not shown) for recovering steam, e.g., a boiler may be provided at a subsequent stage of the reforming apparatus, and steam obtained by the boiler may be introduced into the reforming apparatus.

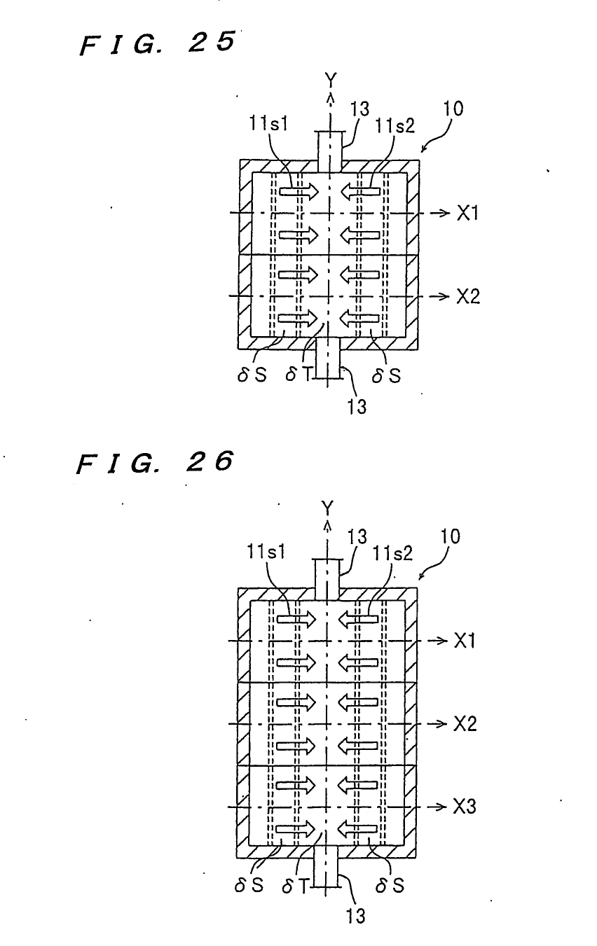

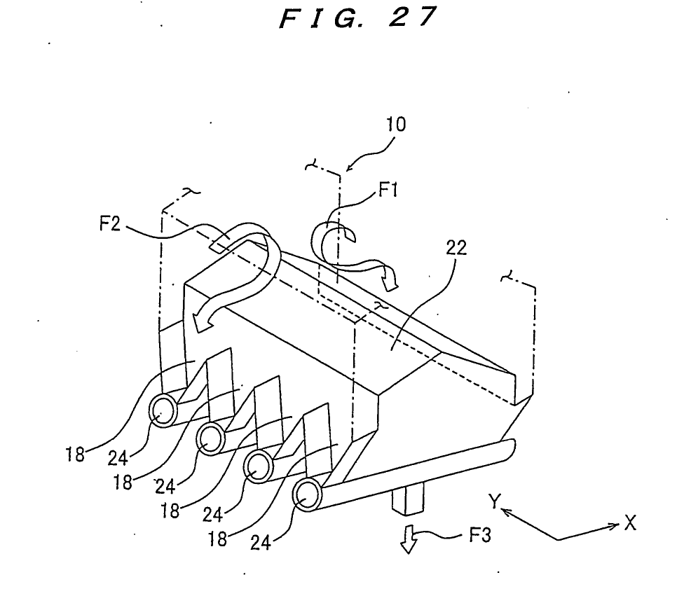

Next, a gasification apparatus comprising combinations of a plurality of modular-type fluidized-bed gasification furnaces according to the present invention will be described below. FIG. 25 is a horizontal cross-sectional view of a gasification apparatus comprising two modular-type fluidized-bed gasification furnaces, FIG. 26 is a horizontal cross-sectional view of a gasification apparatus comprising three modular-type fluidized-bed gasification furnaces, and FIG. 27 is a perspective view showing a gasification apparatus comprising four modular-type fluidized-bed gasification furnaces, as viewed obliquely from above.

As shown in FIGS. 25 through 27, each of the gasification apparatuses comprises a combination of fluidized-bed gasification furnaces each having a substantially rectangular horizontal cross section, and the gasification apparatus has a structure similar to the fluidized-bed gasification furnace shown in FIGS. 4A through 4C, but is extended in the Y direction without a change of the distance in the X (X1, X2, X3) direction. With the above structure, it is possible to increase a processing capability while maintaining the function of the fluidized bed shown in FIGS. 4A through 4C, i.e., the function of a unit of a gasification furnace. From the standpoint of an increase in the processing capability, a cluster of modular-type gasification furnaces is not limited to the arrangements shown in FIGS. 25 through 27, but may comprise a combination of modular-type gasification furnaces according to the respective embodiments described above by extending dimensions in the Y direction, or the like.

In FIG. 27, the arrows F1, F2, F3 represent the directions in which the fluidized medium flows. It is a matter of course to increase the size of a furnace by extending the shape of the furnace in the Y direction, rather than employing modular-type furnaces.

The furnace thus increased in size provides good cost-effectiveness because the facility cost and the operating cost per the amount of materials to be processed are lower and the electric generating efficiency of the boiler increases. Since the stability of operation is higher, it is possible to suppress the discharge of harmful substances such as dioxin, etc.

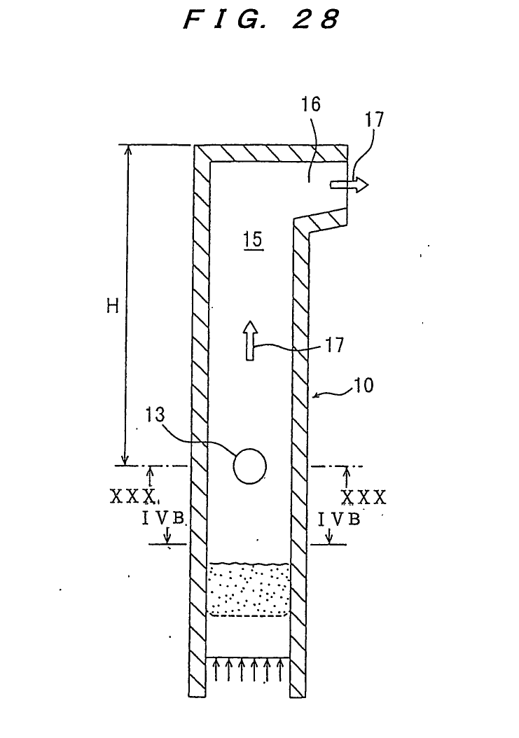

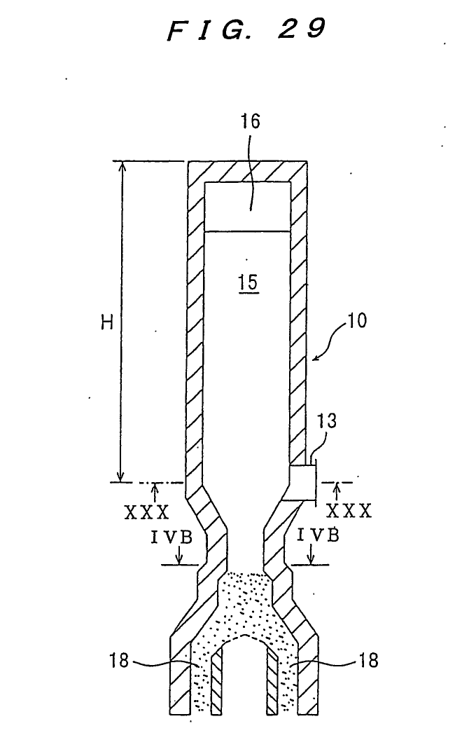

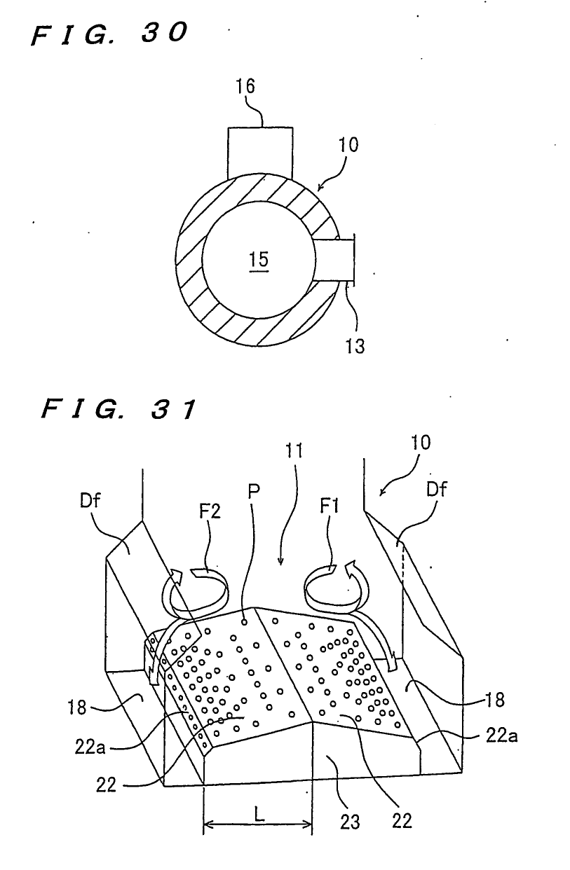

In the above embodiments, the horizontal cross section of a fluidized-bed gasification furnace is a rectangular shape as shown in FIG. 4B or any of shapes as shown in FIGS. 10, 11, 12, and 13. However, the shape of the furnace which corresponds to the fluidized bed may be any one of those shapes. Specifically, the horizontal cross section of the entire furnace does not need to be any one of those shapes. For example, in fluidized-bed gasification furnaces shown in FIGS. 28 and 29, the horizontal cross section taken along line XXX-XXX (upper portion) may be circular as shown in FIG. 30, and the horizontal cross section taken along line IVB-IVB (lower portion) may be rectangular as shown in FIG. 4B. That is, a range H from the horizontal cross section XXX-XXX to the furnace top may be of a substantially circular horizontal cross section, and a region below the horizontal cross section IVB-IVB may be of a substantially rectangular horizontal cross section or any of shapes as shown in FIGS. 10, 11, 12, and 13. In each of the figures, a plurality of waste feeders 103 may be provided.

FIG. 31 is a schematic view showing a general structure of another fluidized-bed gasification furnace according to the present invention. In the present fluidized-bed gasification furnace, a wind box 23 is not divided by partition plates unlike the fluidized-bed gasification furnace as shown in FIGS. 1A and 4A in order to supply a fluidizing gas having a larger mass velocity and a fluidizing gas having a smaller mass velocity. In order to form a descending fluidized bed in which the fluidized medium descends and an ascending fluidized bed in which the fluidized medium ascends within the fluidized bed 11, the diameter and pitch interval of fluidizing gas supply nozzles P on the furnace bottom 22 are appropriately designed for producing circulating flows of the fluidized medium as indicated by the arrows F1, F2 in FIG. 27.

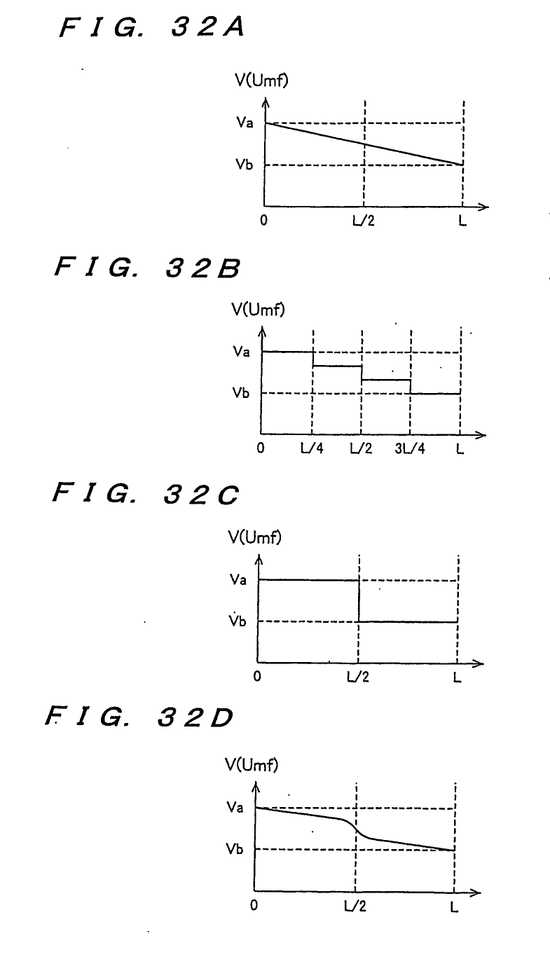

Specifically, unlike the fluidized-bed gasification furnace of the structure shown in FIGS. 4A through 4C, the mass velocity of the fluidizing gas may be changed continuously or stepwise, though a fluidizing gas having a greater mass velocity is supplied to lower sides of the inclined hearth on the furnace bottom 22 near the incombustibles discharging portions 18 and a fluidizing gas having a smaller mass velocity is supplied to higher sides of the inclined hearth on the furnace bottom 22, as with the embodiment shown in FIGS. 4A through 4C. The fluidizing gas whose mass velocity is changed continuously or stepwise is illustrated in graphs shown in FIGS. 32A, 32B, and 32D. FIG. 32C shows, for comparison, the fluidizing gas whose mass velocity is changed in the fluidized-bed gasification furnace shown in FIGS. 4A through 4C. The horizontal axis represents the horizontal distances L from the incombustibles discharging portions 18 to the center of the furnace, and the vertical axis represents the mass velocity V (Umf) of the fluidizing gas that is supplied from the fluidizing gas supply nozzles P into the furnace.

It is possible to form a circulating flow of the fluidized medium even when the mass velocity V of the fluidizing gas is changed continuously as shown in FIG. 32A or when the mass velocity V of the fluidizing gas is changed in many steps as shown in FIGS. 32B and 32D. In the above fluidized-bed gasification furnace, the incombustibles discharging portions 18 are provided in peripheral regions of the furnace. However, even if the incombustibles discharging portion is provided at the central part of the furnace (e.g., as shown in FIGS. 15A and 15B), it is possible to form a circulating flow of the fluidized medium without partition plates in the wind box. In the case where a wind box is provided, the positions of partition plates in the wind box are not limited to those in the above embodiments insofar as the distributions of the mass velocity V (Umf) of the fluidizing gas can be achieved as shown in FIGS. 32A, 32B, and 32D.

As described above, the present invention offers the following excellent advantages:

(1) The fluidized bed has a substantially rectangular horizontal cross section, and the fluidized bed has a circulating flow having a descending flow (descending fluidized bed) of the fluidized medium and an ascending flow (ascending fluidized bed) of the fluidized medium. Therefore, the width of the hearth corresponding to the ascending fluidized bed is not smaller compared with the width of the hearth corresponding to the descending fluidized bed unlike the conventional cylindrical fluidized-bed gasification furnace, and hence the fluidized medium in the fluidized bed can move sufficiently. Therefore, the char is sufficiently turned into fine particles, and the char and the incombustibles can efficiently be classified. The char is thus prevented from entering the incombustibles discharging portions.

(2) As the incombustibles discharging portions for discharging the fluidized medium and the incombustibles accompanying the fluidized medium are continuously provided below the circulating flow of the fluidized medium, portions between incombustibles discharging portions do not present an obstacle to the downward movement of the fluidized medium unlike the conventional fluidized-bed gasification furnace, and the fluidized medium of the fluidized bed smoothly moves downwardly to the incombustibles discharging portions. Therefore, even when unburned carbon components such as char contained in the fluidized medium are combusted, the region where the unburned carbon components are combusted is not locally increased in temperature, and clinker is not produced by the fusion of the fluidized medium.

(3) Since the horizontal cross section of the fluidized bed is of a substantially rectangular shape or a shape which can be modularized, it is possible to increase the size of the hearth while maintaining the function of the gasification furnace irrespective of the magnitude of the area of the hearth.

(4) The fluidized bed has a substantially rectangular horizontal cross section, and incombustibles discharging portion (or portions) is (or are) defined at one side (or a pair of facing sides) of the fluidized bed for discharging the fluidized medium and the incombustibles accompanying the fluidized medium, and is (or are) disposed at the lower end of the fluidized bed. With such an arrangement, it is possible to increase the size of the gasification furnace while maintaining the function of the fluidized-bed furnace so as not to cause an abnormal state of fluidization.

(5) Inasmuch as the freeboard has a substantially circular horizontal cross section, the freeboard has increased structural strength, and any reinforcing members required by the freeboard can greatly be reduced. The freeboard which is of a substantially circular horizontal cross section greatly prolongs the service life of the refractory material and greatly reduces expenses for repairing the refractory material.

(6) The means or device for forming a circulating flow of the fluidized medium has a fluidized-bed bottom inclined toward the incombustibles discharging portion, a fluidizing gas supply means (or device) for ejecting a fluidizing gas having a greater mass velocity and a fluidizing gas having a smaller mass velocity from the inclined fluidized-bed bottom, and a deflector. Consequently, the fluidized medium and the incombustibles accompanying the fluidized medium are given forces so as to move in the fluidized bed downwardly toward the incombustibles discharging portion due to the inclined fluidized-bed bottom, and hence can smoothly be directed toward the incombustibles discharging portion.

(7) By forming a circulating flow of the fluidized medium, the fluidized-bed gasification furnace converts combustible components and ash contained in combustibles supplied thereto into fine particles, and delivers the fine particles with a large quantity of heat to the slagging combustion furnace disposed at the subsequent stage of the fluidized-bed gasification furnace, and has a damping function to absorb qualitative and quantitative fluctuations of the charged combustibles and average qualitative and quantitative fluctuations of combustibles and ash to be delivered to the subsequent stage.

(8) By forming a circulating flow of the fluidized medium, the temperatures in the overall fluidized bed are uniformized, and heat is prevented from being localized in the fluidized bed. Therefore, it is possible to prevent an abnormal state of fluidization from occurring owing to clinker formed in local high-temperature regions.

(9) In the fluidized bed having a substantially rectangular horizontal cross section, the incombustibles are led together with the fluidized medium by the circulating flow along the inclined furnace bottom to the incombustibles discharging portion, and are not deposited at the end portion connected to the incombustibles discharging portion but are discharged without stagnation due to the sharp gradient and fluidization.

(10) The vertical chutes having a predetermined length are disposed substantially vertically so as to be in communication with the incombustibles discharging portions for allowing incombustibles to be discharged smoothly without being stagnant in the vertical chutes. The vertical chutes are densely filled with the fluidized medium, which provides a material sealing action to prevent the fluidizing gas (mainly air) from leaking to the incombustibles discharging paths. Unburned carbon components such as char moving downwardly to the incombustibles discharging paths are prevented from being combusted, thus producing no clinker.

(11) Since inclined chutes which are the cause of a weak material sealing action are substantially eliminated, the ability to discharge incombustibles can be increased without impairing the sealing capability. The vertical chutes and the incombustibles discharging device which combines the vertical chutes are structurally simple and can easily be installed. Specifically, the horizontal cross section of the fluidized bed is substantially rectangular, and the vertical chutes having a predetermined length that are disposed substantially vertically so as to be in communication with the incombustibles discharging portions are of a structure for allowing incombustibles to be well discharged (e.g., a structure comprising a single chute). Because any special device (a conveyor or an inclined chute) which has heretofore been indispensable for combining four incombustibles discharging chutes is not required, incombustibles do not become stagnant in chutes, and can be discharged more reliably.

(12) A material seal can be maintained in the lower portion of the furnace even if the height of the system below the furnace is smaller than that of the conventional system. Consequently, the height of the overall system which has posed a problem in the layout of various devices of the system, particularly the height of the combustible supply device, can be reduced as a whole.

### INDUSTRIAL APPLICABILITY

The present invention is preferably applicable to a fluidized-bed gasification furnace in a gasification and slagging combustion system for gasifying combustibles such as municipal wastes, industrial wastes, and biomass, delivering produced gas and char (solid carbon) into a slagging combustion furnace, and combusting the gas and char and melting ash in the slagging combustion furnace.

1. A fluidized-bed gasification furnace for gasifying combustibles, comprising:
a fluidized bed having a substantially rectangular horizontal cross section, a circulating flow of a fluidized medium being formed in said fluidized bed, and combustibles supplied to said fluidized bed being gasified in said circulating flow of the fluidized medium to produce gas and char; and
at least one incombustibles discharging portion defined at at least one side of said fluidized bed for discharging the fluidized medium and incombustibles accompanying the fluidized medium, said at least one incombustibles discharging portion being disposed at the lower end of said fluidized bed.

2. A fluidized-bed gasification furnace according to claim 1, wherein said at least one incombustibles discharging portion comprises two incombustibles discharging portions at a pair of facing sides of said fluidized bed.

3. A fluidized-bed gasification furnace according to claim 1, wherein said fluidized bed is surrounded by furnace walls having a substantially rectangular inner surface in horizontal cross section.

4. A fluidized-bed gasification furnace according to claim 1, wherein said incombustibles discharging portion is provided below a central portion of said fluidized bed.

5. A fluidized-bed gasification furnace according to claim 1, wherein a freeboard located above said fluidized bed has a substantially circular horizontal cross section.

6. A fluidized-bed gasification furnace according to claim 1, wherein an apparatus for forming said circulating flow of the fluidized medium comprises a fluidized-bed bottom inclined toward said incombustibles discharging portion, and a fluidizing gas supplying apparatus for supplying fluidizing gases having substantially different mass velocities from the inclined fluidized-bed bottom.

7. A fluidized-bed gasification furnace according to claim 6, wherein said apparatus for forming said circulating flow of the fluidized medium further comprises a deflector.

8. A fluidized-bed gasification furnace according to claim 1, wherein a fluidized-bed bottom is inclined toward said incombustibles discharging portion and has an end portion connected to said incombustibles discharging portion, said end portion is inclined at 45 degrees or more, and a fluidizing gas is blown into from said end portion.

9. A fluidized-bed gasification furnace according to claim 1, further comprising:
a vertical chute having a fixed length which is substantially vertically disposed and communicates with said incombustibles discharging portion; and
an incombustibles discharging apparatus for discharging the incombustibles from said fluidized-bed gasification furnace, said incombustibles discharging apparatus being provided below said vertical chute to communicate with said vertical chute.

10. A fluidized-bed gasification furnace according to claim 9, wherein said incombustibles discharging apparatus discharges the incombustibles horizontally.

11. A fluidized-bed gasification furnace for gasifying combustibles, comprising:
a fluidized-bed having a substantially rectangular horizontal cross section; and
a freeboard having a substantially circular horizontal cross section,
wherein a circulating flow of a fluidized medium is formed in said fluidized bed, and combustibles supplied to said fluidized bed are gasified to generate gas and char.

12. A fluidized-bed gasification and slagging combustion system, comprising:
a fluidized-bed gasification furnace according to claim 1; and
a slagging combustion furnace for combusting the gas and char produced in said fluidized-bed gasification furnace and melting ash.

13. A fluidized-bed gasification and slagging combustion system, comprising:
a fluidized-bed gasification furnace according to claim 11; and
a slagging combustion furnace for combusting the gas and char produced in said fluidized-bed gasification furnace and melting ash.

14. A fluidized-bed gasification furnace according to claim 2, wherein said fluidized bed is surrounded by furnace walls having a substantially rectangular inner surface in horizontal cross section.

15. A fluidized-bed gasification furnace according to claim 2, wherein said incombustibles discharging portion is provided below a central portion of said fluidized bed.

16. A fluidized-bed gasification furnace according to claim 3, wherein said incombustibles discharging portion is provided below a central portion of said fluidized bed.

17. A fluidized-bed gasification furnace according to claim 14, wherein said incombustibles discharging portion is provided below a central portion of said fluidized bed.

18. A fluidized-bed gasification furnace according to claim 2, wherein a freeboard located above said fluidized bed has a substantially circular horizontal cross section.

19. A fluidized-bed gasification furnace according to claim 3, wherein a freeboard located above said fluidized bed has a substantially circular horizontal cross section.

20. A fluidized-bed gasification furnace according to claim 14, wherein a freeboard located above said fluidized bed has a substantially circular horizontal cross section.
